(19) United States
(12) Patent Application Publication
(10) Pub. No.: US 2012/0117226 A1
(43) Pub. Date: May 10, 2012

(54) MONITORING SYSTEM OF COMPUTER AND MONITORING METHOD

(75) Inventors: Tsuyoshi TANAKA, Kokubunji (JP); Keitaro UEHARA, Machida (JP); Shinichi KAWAMOTO, Tokyo (JP)

(73) Assignee: HITACHI, LTD., Tokyo (JP)

(21) Appl. No.: 13/287,160

(22) Filed: Nov. 2, 2011

(30) Foreign Application Priority Data
Nov. 5, 2010 (JP) 2010-248253

(51) Int. Cl. G06F 15/173

(52) U.S. Cl. 709/224

(57) ABSTRACT

There is provided a monitoring system capable of representing relationships of computer resources that virtual servers use in a tree structure and aggregating the performance statistics of the virtual resources sharing physical resources. The monitoring system has: a virtualization module that makes virtual computers operate; and a monitoring module for monitoring the physical computers and components of the virtual computers. The monitoring module designates the physical computer and the components of the virtualizing module as base resources, manages the components of the virtual computers as virtual resources, generates a platform tree by extracting a tree structure from the virtual resources and the components of the base resources for predetermined platforms, generates a service provision tree by extracting a tree structure having the base or virtual resources as starting points, and establishes a reference relationship for the components contained in the platform tree and also contained in the service provision tree.

### CLAIM OF PRIORITY

The present application claims priority from Japanese patent application JP 2010-248253 filed on Nov. 5, 2010, the content of which is hereby incorporated by reference into this application.

### FIELD OF THE INVENTION

The present invention relates to a monitoring system of a computer system that includes multiple physical resources and multiple virtual resources.

### BACKGROUND OF THE INVENTION

### <Trend of Business World in Operations Management>

In data centers that operate computer systems or the like, there are increasing vendors each of which supports or is planning to support description of management information, such as of network apparatuses, storage devices, server machines, OS, and server virtualization software in an XML format. Furthermore, a trend in which exchange of management information between apparatuses and between operation software is performed with an XML format file is also increasing.

As a standardized specification of these pieces of operations management information, a method for describing management information on a base of a model of system management information CIM (Common Information Model) that DMTF (Distributed Management Task Force) draws up is permeating. Although the CIM is modeled with the UML, data related to the device is operated in the XML format. Under such a background, it becomes a standard technique to describe configuration information of the system by the XML in a field pertaining to operations management.

### <About Monitoring System>

In corporate information systems and data centers, a need of integrating a large number of computer systems that are built in accordance with business development and performing the collective operations management is growing. In integrating the systems, virtual technologies of systems including server virtualization are underlying as their bases, and are spreading widely.

On the other hand, in a steady maintenance work of a computer system, performance statistics about various devices is periodically collected from the system devices, such as a server, that are to be monitored by collecting it with a performance monitoring tool and automatically operating execution of a shell script etc. using a tool capable of scheduling it.

In most cases, the configuration information of the computer system is managed on a worksheet of spreadsheet software. In order to update the configuration information, it is necessary for an administrator etc. to check current configuration information as to whether a record of the configuration information is correct. Since in this check of the configuration information, pieces thereof are various, such as one that is automatically collected using an industry standard interface, such as SNMP, and one that is confirmed through interview of a person in charge of the device because the persons in charge are different on a device basis, connection relationships of the entire system (between the server and others, i.e. a storage, a network, etc.) are often recorded in a drawing on work sheet. The relationships on the drawing are checked making full use of functions, such as grouping and an order of objects.

Moreover, in data centers or others, the performance statistics about operations of the computer and devices that are operating is automatically collected by software etc. in addition to the configuration information of the computer system, and the administrator etc. analyzes an operating stage from the performance statistics. Triggers to conduct an operational condition analysis include formation of a periodical report of an operational condition to customers and a case where an alert occurs in threshold monitoring of the configuration information. In the operational condition analysis, the administrator etc. executes a working of finding the physical resources that the virtual servers share from the configuration information of the computer system at the time of wishing to conduct the check, while performing trial-and-error. Alternatively, it is routinely conducted that the administrator etc. makes a guess of a problem occurrence position by comparing the configuration information at the time of occurrence of the problem and the configuration information before the occurrence of the problem. For example, the administrator etc. determines whether performance bottleneck occurs at the position seeing a total utilization of the physical resources from the performance statistics. Then, the administrator etc. judges which virtual server affects the performance by seeing the performance statistics.

In the case where the performance statistics that is focused on the configuration information could not be collected, it is necessary for the administrator etc. to examine whether it can be inferred from other performance statistics that has been successfully collected from the configuration information and to infer a situation of utilization of each virtual server on the physical resources from the existing data. However, in a work for monitoring the operational condition, the administrator etc. performs (1) management of the configuration information, (2) investigation of the relationship between performance information and the configuration information, and (3) inference of the performance information of the physical resources shared through virtualization, manually applying a trial-and-error method, which requires a man-hour dramatically.

On the other hand, in data centers etc., there is a possibility that introduction of a virtualization technology will increase the number of virtual servers to be operated to an order of a few tens of thousand. In order to improve efficiency of the operations management of the virtual servers of an order of tens of thousands of sets, it is necessary to economize the above-mentioned operational condition analysis.

Although the technology of Japanese Unexamined Patent Application Publication (Translation of PCT application) No. 2007-524889 describes the configuration information using the XML, it does not display operation performance statistics and the configuration information that are related with each other.

The technology of United States Patent Application No. 2008/0163234 automatically acquires the current relationship between a virtual server and a storage device, with the storage device being set in the center, displays it as a configuration diagram, and displays relation thereof with the performance statistics of system components.

### SUMMARY OF THE INVENTION

However, with the technology of Japanese Unexamined Patent Application Publication (Translation of PCT application) No. 2007-524889 of the above-mentioned conventional example, although a history of performance statistics is recorded, a history of the configuration information is not acquired. Moreover, with the technology of United States Patent Application No. 2008/0163234, analysis of the performance statistics over system components, for example, performance prediction of HBA (Host Bus Adaptor) is not performed from data of a storage.

Since a history of the configuration information is not acquired with the technology of United States Patent Application No. 2008/0163234, it gives rise to a need of remaking a configuration diagram if needed. Let it be assumed that a history of the table is temporarily taken for the history of the configuration information. Designating the number of system components by M, the number of relationships between the system components (group) by N, and the number of operations (time) by O, a time equal to O(S2) times will take in the following thinking.

That is, assuming a case where the virtual server is moved onto the physical server, in the case of the table, addition of the virtual server will cause new row and column to be added, the table will be remade at every configuration change. A relationship of the number of relationships among system components, the number of servers, and the number of system components becomes O(N×M)=O(S×S)=0 (S²) because N∝S and M×S.

In a future data center, it is expected that the number of virtual servers will reach tens of thousands of sets, and addition and deletion of virtual servers will be performed frequently on a daily basis. Under this precondition, when the relationship between system components was managed with a table, there was a problem of taking a time (data volume and a cost of table generation) of O(S²) times each time change of the virtual server was made.

In order to solve problems of the technological background and the prior art described above, it is necessary to make operational conditions of physical resources that the virtual servers share easily analyzable by acquiring history management of the configuration information of the computer system and the performance statistics and associating the history of the configuration information, the performance statistics, and the configuration information. Furthermore, there is a problem of reducing a cost at the time of configuration change, such as addition and deletion of the virtual server.

Then, the object of the present invention is to enable the relationships of computer resources that a virtual server uses to be represented in a tree structure without omission, and to enable the performance statistics of the virtual resources that share physical resources to be automatically aggregated in a monitoring system that displays relation between the configuration information and the performance statistics of the computer system.

The present invention is a monitoring system of a computer that has one or more physical computers, a virtualization module that is executed by the physical computer to make one or more virtual computers operate, and a monitoring module for monitoring the one or more virtual computers operating on the virtualization module, components of the physical computers, and components of the virtual computers, wherein the monitoring module designates the physical resources that are the components of the physical computers and the components of the virtualization module conjunctionally as base resources, manages the components of the virtual computers operating on the virtualization module as virtual resources, generates a platform tree by extracting a tree structure of the components of the virtual resources and the components of the base resources for every predetermined platform, generates a service provision tree by extracting a tree structure that has the base resources being configured by predetermined transformation information or the virtual resources as its starting points from the components of the virtual resources, configures reference information indicating that the components contained in the platform tree and also contained in the service provision tree are referred to, and establishes reference relationships between the components of the platform tree and the service provision tree.

Therefore, according to the present invention, it becomes possible to manage the relationship between virtual server and the base resources that the virtual server uses without omission and using a small amount of time. Furthermore, it becomes possible to analyze a situation of utilization of an arbitrary component for each virtual server from the performance statistics about the operation. Moreover, it becomes possible to navigate an efficient view of the performance statistics by the user analyzing the performance statistics according to the tree structure. By these capabilities, it is possible to shorten a time required to detect a bottleneck of the computer resources from the performance information and to improve an efficiency of the operations management in an environment where the computer system is equipped with a large number of computers.

In comparison with the above-mentioned Japanese Unexamined Patent Application Publication (Translation of PCT application) No. 2007-524889, the present invention outputs the configuration information by the tree structure. Therefore, a cost required for addition and deletion does not depend on the number of the servers and varies only for a portion to which the servers are related. Consequently, they can be executed at a cost of O(1). Here, designating the number of servers by S, since the data volume is proportional to the number of servers, the cost becomes O(s); therefore, it is possible to reduce the cost required for management and the data volume, as compare with the above-mentioned conventional technology.

### BRIEF DESCRIPTION OF THE DRAWINGS

FIG. 1 shows an embodiment of the present invention and is a block diagram of an entire computer system including a computer monitoring system to which the present invention is applied;

FIG. 2 shows the embodiment of the present invention and is a block diagram showing an internal configuration of a monitoring system 100;

FIG. 3 shows the embodiment of the present invention and is a composition example of a performance statistics table 120;

FIG. 4 shows the embodiment of the present invention and is a composition example of a configuration information management table 130;

FIG. 5 shows the embodiment of the present invention and is a composition example of a configuration information change history management table 140;

FIG. 6 shows the embodiment of the present invention and is a composition example of a component history management table 150;

FIG. 7 shows the embodiment of the present invention and is an explanatory diagram that excerpts a part of a tree representation of a configuration information XML 500a;

FIG. 8 shows the embodiment of the present invention and is an explanatory diagram that excerpts a part of the tree representation of the configuration information XML 500a;

FIG. 9 shows the embodiment of the present invention and is an explanatory diagram that excerpts a part of a tree representation of a configuration information XML 500b;

FIG. 10 shows the embodiment of the present invention and is an explanatory diagram that excerpts a part of a tree representation of a configuration information XML 500c;

FIG. 11 shows the embodiment of the present invention and is a diagram of stage transition of a component ID that a configuration information relation management module 230 manages;

FIG. 12 shows the embodiment of the present invention and is a composition example of an assigned ID management table 160 equivalent to the configuration information XML 500a;

FIG. 13 shows the embodiment of the present invention and is a composition example of the assigned ID management table 160 equivalent to the configuration information XML 500a;

FIG. 14 shows the embodiment of the present invention and shows a flowchart of a processing performed in a performance information management module 190 at the time of displaying operation performance statistics;

FIG. 15 shows the embodiment of the present invention and is a screen image showing one example of the operation statistics monitor screen displayed on a terminal 350 of the monitoring system 100;

FIG. 16 shows the embodiment of the present invention and is a block diagram showing a configuration of a performance statistics collector 300;

FIG. 17 shows the embodiment of the present invention and is an explanatory diagram of a definition of a performance statistics collection parameter 310 that the performance statistics collector 300 uses;

FIG. 18 shows the embodiment of the present invention and shows a flowchart of a processing performed in the performance statistics collector 300;

FIG. 19 shows the embodiment of the present invention and shows a detailed flowchart of a statistic registration processing 1580 performed in a performance statistics registration module 340;

FIG. 20 shows the embodiment of the present invention and is a block diagram showing details of a configuration manager 360;

FIG. 21 shows the embodiment of the present invention and is an explanatory diagram showing one example of a configuration information generation policy 240 that a configuration change request generation module 364 outputs;

FIG. 22 shows the embodiment of the present invention and is a block diagram of a virtual computer system showing one example of monitored resources 400;

FIG. 23 shows the embodiment of the present invention and is a diagram that excerpts a part of the tree representation of the configuration information XML 500a;

FIG. 24 is an explanatory diagram of an example that represents a configuration diagram of a computer system to which virtualization is applied using nodes (vertexes) and edges (sides);

FIG. 25 is an example showing data representation for automatically calculating the performance statistics of a platform layer from the performance statistics of a service provision layer;

FIG. 26 shows the embodiment of the present invention and is a composition example of a performance statistics analysis table 115;

FIG. 27 shows the embodiment of the present invention and is a composition example of a pop-up window input screen 2015 on which an operation of the performance statistics analysis is specified;

FIG. 28 shows the embodiment of the present invention and is a diagram showing a flowchart of automatically calculating the performance statistics of the platform layer from the performance statistics of the service provision layer;

FIG. 29 shows the embodiment of the present invention and is a screen image showing a composition example of an output screen where the performance statistics of the platform layer is automatically calculated from the performance statistics of the service provision layer;

FIG. 30 shows an embodiment of a first modification of the present invention and is a diagram showing a composition example of a performance analysis navigation screen;

FIG. 31 shows the embodiment of the first modification of the present invention and is a diagram showing a flowchart of performance analysis navigation;

FIG. 32A shows the embodiment of the present invention and is a first half part of a diagram that excerpts a part of the XML representation of the configuration information XML 500a;

FIG. 32B shows the embodiment of the present invention and is a second half part of the diagram that excerpts the part of the XML representation of the configuration information XML 500a;

FIG. 33 shows the embodiment of the present invention and is a diagram that excerpts a part of the XML representation of the configuration information XML 500a.

FIG. 34A shows the embodiment of the present invention and is a first half part of a diagram showing an change portion of the XML representation when configuration change from the configuration information 500a to the configuration information XML 500b is performed;

FIG. 34B shows the embodiment of the present invention and is a second half part of the diagram showing the change portion of the XML representation when configuration change from the configuration information 500a to the configuration information XML 500b is performed;

FIG. 35A shows the embodiment of the present invention and is a first half part of a diagram showing an change portion of the XML representation when configuration change from the configuration information 500a to the configuration information XML 500b is performed;

FIG. 35B shows the embodiment of the present invention and is a second half part of the diagram showing the change portion of the XML representation when configuration change from the configuration information 500a to the configuration information XML 500b is performed;

FIG. 36 shows the embodiment of the present invention and is an explanatory diagram showing one example of a baseline configuration table;

FIG. 37 shows the embodiment of the present invention and is an explanatory diagram showing one example of an xpath generation table;

FIG. 38 shows the embodiment of the present invention and is a flowchart showing one example of a node generation processing performed by a configuration manager;

FIG. 39 shows the embodiment of the present invention and is a flowchart showing one example of a tree structure generation processing performed by the configuration manager;

FIG. 40 shows the embodiment of the present invention and is a flowchart showing one example of an xpath generation table setting processing performed by the configuration manager;

FIG. 41 shows the embodiment of the present invention and is a flowchart showing one example of a configuration information generation processing performed by the configuration manager; and

FIG. 42 shows the embodiment of the present invention and is a configuration example of a temporary configuration XML 385.

### DETAILED DESCRIPTION OF THE PREFERRED EMBODIMENTS

Hereafter, one embodiment of the present invention will be explained based on accompanying drawings.

### <Overall Block Diagram>

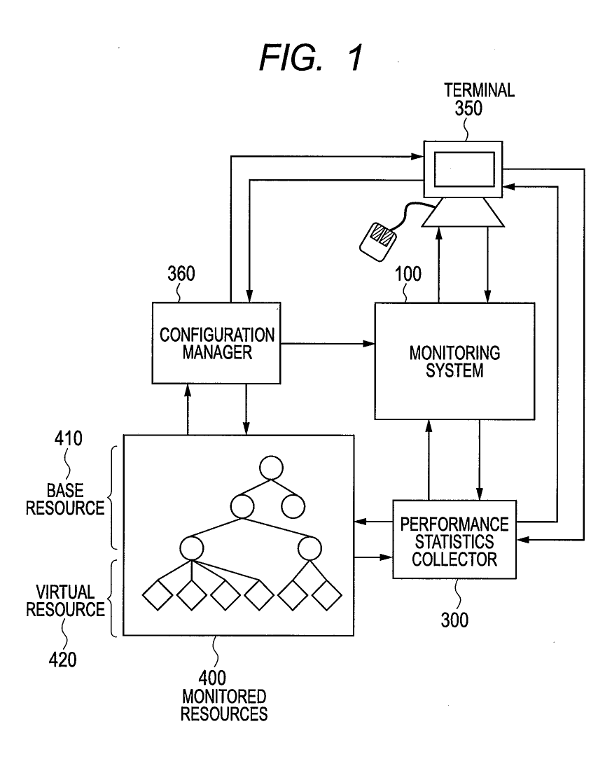

FIG. 1 shows a first embodiment and is an overall block diagram of a computer system including a computer monitoring system to which the present invention is applied. The computer system includes: a computer resource that becomes a monitored object (hereafter, referred to as a monitored resource) 400; a monitoring system (a monitoring apparatus) 100; a performance statistics collector 300; a configuration manager 360 for managing a configuration of the monitored resources 400; and a terminal 350 for referring to information that the monitoring system 100 collected.

The monitored resources 400 include base resources 410 that include a rack, a physical server (physical computer), a storage, and software (the hypervisor or the virtual machine monitor) for virtualizing resources of a network and the physical servers (physical resources), and virtual resources 420, such as a virtual server (a virtual computer), a virtual (or logical) storage, a virtual network, and software (a guest OS) operating on the virtual server.

The virtual resources 420 include pieces of information, such as statistics (performance statistics) of operation information indicating resource utilizations of the base resources 410 and the virtual resources 420, power consumption of the base resources 410, environmental information of a temperature of exhaust from the device etc., and a log indicating the operational condition.

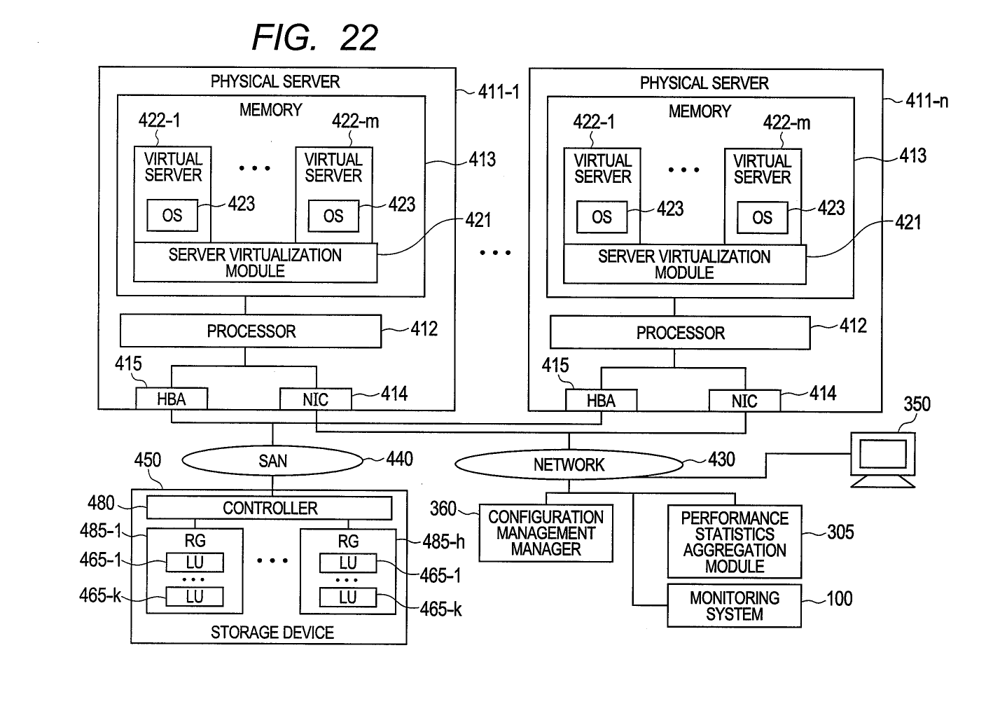

The performance statistics collector 300 may operate in the following two ways: a case of operating on the same computer as the monitored resources 400 do; and a case of operating on a different computer from thereof. In this embodiment, the performance statistics collector 300 shall perform on any one of physical servers 411-1 to 411-n described in FIG. 22. Incidentally, the server that makes the performance statistics collector 300 perform may be the physical server or may be the virtual server. The configuration manager 360 and the monitoring system 100 have the same situation and may be operated on different computers. In both cases, a difference in operational condition does not affect essential of the present invention. No that, in this embodiment, the configuration manager 360 and the monitoring system 100 shall perform on only any one of the physical servers 411-1 to 411-n.

In this embodiment, the monitored resources 400 shall include base resources and virtual resources.

The base resources 410 of the monitored resources 400 are comprised of principally the multiple physical computers (physical servers) 411-1 to 411-n and a server virtualization module 421 for generating a virtual server 422 shown in FIG. 22. Each computer has a physical processor, memory, and an interface, and is connected to a storage device 450 and a network 430 through the interface. These physical computer resources are designated as the physical resources. The base resources 410 include the server virtualization module (the hypervisor or a VMM) 421 that is loaded to memory 413 and is executed by a processor 412. That is, the base resources 410 are the physical resources added with the server virtualization module 421 (a logical resource). Therefore, in the explanation below, the base resources 410 with the server virtualization module 421 deleted are designated as the physical resources.

In the present invention, it is defined that the virtual resources operate on the base resources.

The virtual resources 420 include virtual servers 422-1 to 422-m, LUs (LU: logical disk) 465-1 to 465-k of the storage device 450 that the OS 423 and the OS 423 performing on each virtual server access, and the virtualized I/O devices (a virtual NIC and a virtual HBA). The virtual resources 420 include virtual or logical resources that the server virtualization module 421 allocates to the virtual server 422.

Incidentally, although not illustrated, in the case where a server virtualization module is made to operate on the virtual server 422 that is on the server virtualization module 421, the server virtualization module on the virtual server 422 can be dealt with as the base resource.

As a concrete example of the monitored resources 400 including the base resources 410 and the virtual resources 420, it becomes as is shown in FIG. 22, for example.

FIG. 22 is a block diagram of a virtual computer system showing one example of the monitored resources 400. The base resources 410 include the multiple physical servers 411-1 to 411-n, the network 430, a SAN (Storage Area Network) 440, the storage device 450, and the server virtualization module 421. Since the physical servers 411-1 to 411-n are of the same configuration, only the physical server 411-1 will be explained below.

The physical server 411-1 includes the processor 412, the memory 413, an NIC (Network Interface Card) 414, and an HBA (Host Bus Adapter) 415. Incidentally, although illustration is not given, it may be equipped with a BMC (Baseboard Management Controller) for performing start, termination, and monitoring of the physical server.

The processor 412 executes various programs stored in the memory 413. The HBA 415 is connected to the storage device 450 through the SAN 440. The NIC414 is connected to the network 430. The NIC414 communicates with other servers in response to requests from various programs mainly on the memory 413. The configuration manager 360 for allocating the base resources 410 to the virtual resources 420 and a performance statistics aggregation module 305 for collecting the operation information of the components of the base resources 410 and the virtual resources 420 are connected to the network 430. Incidentally, the monitoring system 100 and the terminal 350 may be connected to the network 430.

Multiple virtual servers 422-1 to 422-m can be built on the memory 413 by the server virtualization module 421 operating. The server virtualization module 421 includes a virtualization technology called the hypervisor. Incidentally, let a generic term of the virtual servers 422-1 to 422-m be virtual servers 422. In each of the virtual servers 422, the OS (Operating System) 423 can be made to operate independently, respectively. When the server virtualization module 421 is executed by the processor 412, the multiple virtual servers 422 can be built on the server virtualization module 421.

In response to an instruction of the configuration manager 360, the server virtualization module 421 virtualizes the physical resources of the physical server 411-1, and allocates them to the virtual resources 420 that include the virtual servers 422-1 to 422-m as main constituents. Moreover, the server virtualization module 421 virtualizes the NIC 414 and the HBA 415, and provides them to the virtual servers 422-1 to 422-m. The NIC414 and the HBA 415 that are virtualized are designated as the virtual NIC (vNIC) and the virtual HBA (vHBA), respectively. Furthermore, the server virtualization module 421 allocates a virtual processor that virtualized the processor 412 (physical processor 412) and virtual memory that virtualized the memory 413 to the virtual servers 422-1 to 422-m. Incidentally, if the server virtualization module 421 is the hypervisor, a desired number of cores among multiple cores of the processor 412 are assigned to the virtual servers 422-1 to 422-m.

Regarding the virtual servers 422, each independent virtual server 422 is built by the server virtualization module 421 reading and executing an OS image that is stored in the storage device 450 in advance, respectively. Incidentally, in the below, let a generic term of the physical servers 411-1 to 411-n be a physical server 411.

The storage device 450 includes a controller 480 and a RAID Group (hereinafter, abbreviated as a RG) 485-1 to 485-h. In FIG. 22, although only a single controller 480 exists, it sometimes happens that a plurality thereof may exist. The controller 480 is performing read and write of the data from/to the disk drive and control of a fiber channel interface connected to the SAN 440. The RG 485-1 to 485-h are each constructed by RAID that combines one or more hard disk drives (HDDs), respectively. Each of the RG 485-1 to 485-h is logically divided into the logical modules (LUs) 465-1 to 465-k each of which is a logical disk device (or storage device). The each of the LUs 465-1 to 465-k is accessible individually from the virtual servers 422-1 to 422-m. Incidentally, the LUs 465-1 to 465-k should just be nonvolatile storage media, and can be constructed with HDDs and nonvolatile memory. Incidentally, in this embodiment, the RG 485-1 to 485-h are treated as the base resources 410, and the LUs 465-1 to 465-k are treated as the virtual resources 420.

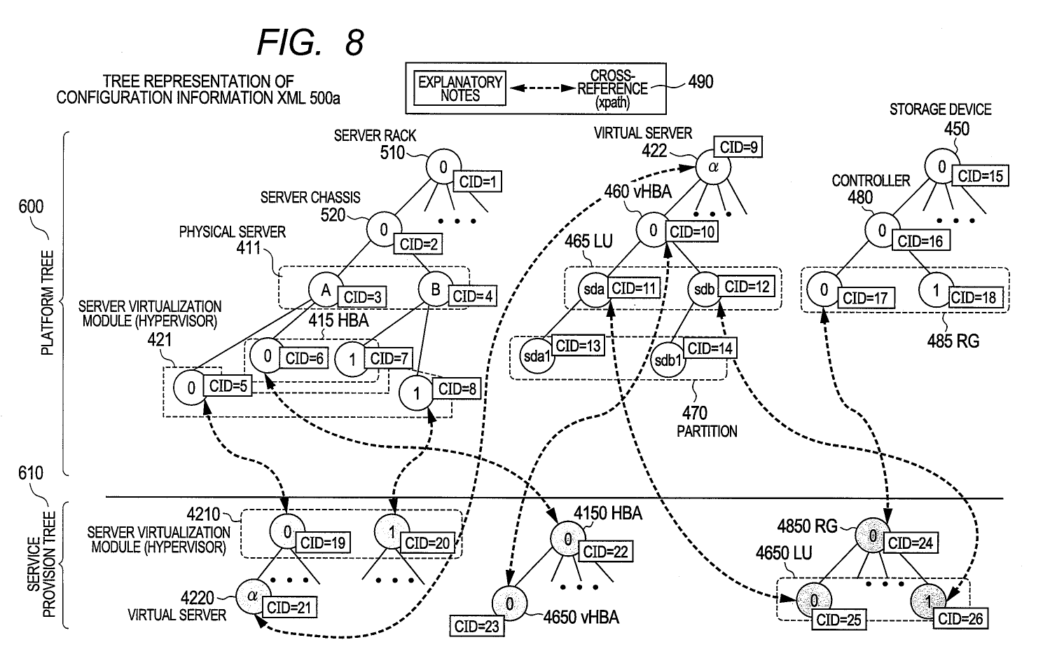

The multiple physical servers 411-1 to 411-n are stored in multiple server chassis 520 shown in FIG. 8, respectively, and the server chassis 520 shows an example where it is constructed with a rack mount server that is to be stored in a server rack 510.

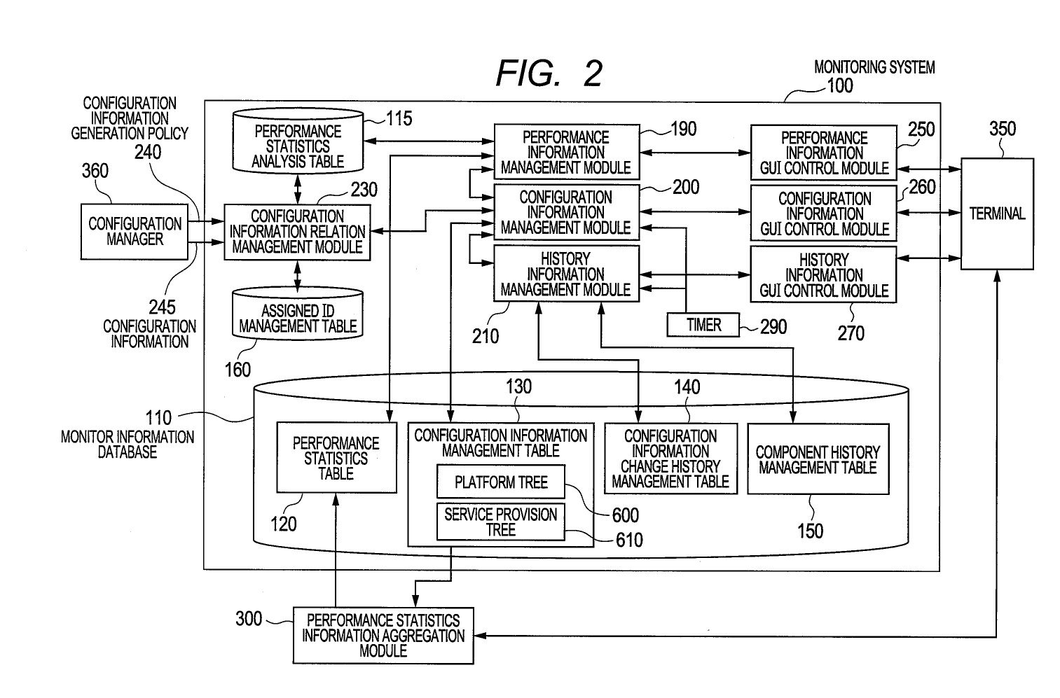

FIG. 2 is a block diagram showing an internal configuration of the monitoring system 100. The monitoring system 100 includes: a monitor information database 110 for storing various information; a performance information GUI control module 250 for controlling an interface with the terminal 350; a configuration information GUI control module 260; a history information GUI control module 270; a performance information management module 190 that accesses the monitor information database 110 based on an instruction from the performance statistics GUI control part 250 and decides information that is outputted to the terminal 350, a configuration information management module 200, a history information management module 210, and a performance statistics analysis table 115 on which a calculation formula for performing a statistical processing on the operation information is registered. Each of these functions is installed as a program, is stored in the storage device 450 serving as a storage medium shown in below-mentioned FIG. 22, is loaded to the memory 413 by the processor 412 of the physical server 411, and is executed.

In the monitor information database 110, a performance statistics table 120, a configuration information management table 130, a configuration information change history management table 140, a component history management table 150, etc. are stored. Incidentally, since the configuration information change history management table 140 and the component history management table 150 are information generated secondarily from the configuration information management table 130, in carrying out the present invention, they are not necessarily required, and are tables prepared to make faster displaying. Moreover, the monitoring system 100 also includes a configuration information relation management module 230 that generates new configuration information according to configuration information 245 and a configuration information generation policy 240 obtained from the configuration manager 360 and an assigned ID management table 160 for managing IDs that are assigned to the configuration information.

One example of the configuration information generation policy 240 received from the configuration manager 360 is as follows, for example: at the time of upgrading the revision of the same configuration information, it inherits component IDs given to respective pieces of the configuration information; at the time of adding new configuration information, it allocates a new component ID; and at the time of deleting the configuration information, it collects the component ID and configures a policy such as inhibiting utilization of the component ID for many occasions in advance.

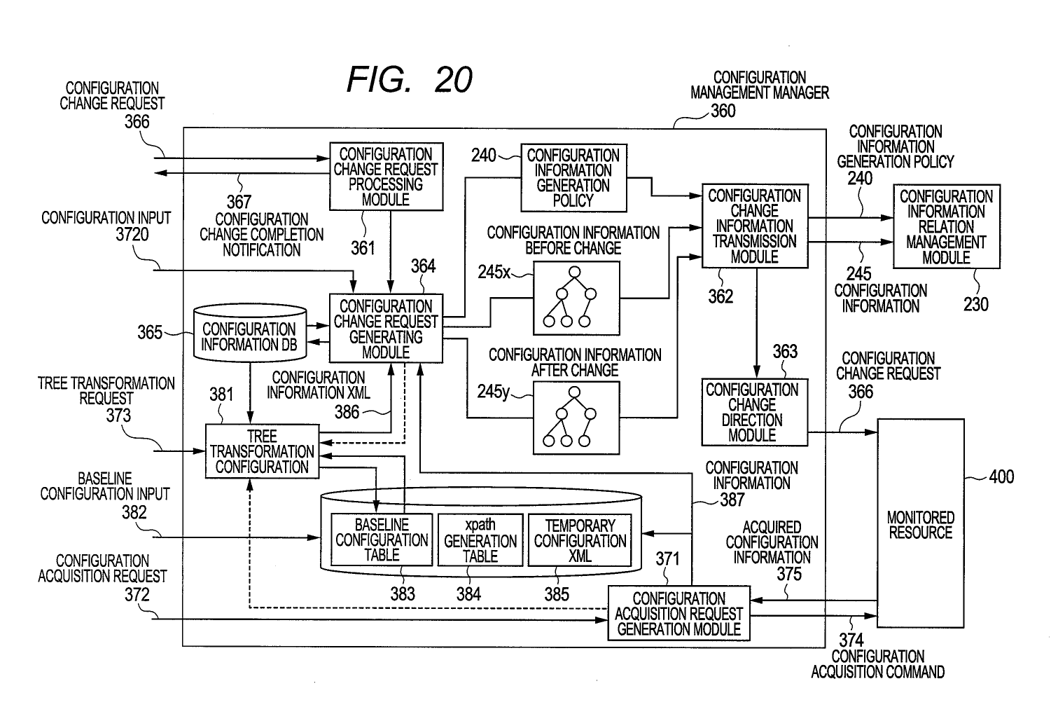

FIG. 20 is a block diagram showing details of the configuration manager 360. The configuration manager 360 manages the followings: a configuration information DB 365 for storing the configuration information of the base resources 410 and the virtual resources 420 for the monitored resources 400; a baseline configuration table 383 for generating a platform tree 600 and a service provision tree 610 from the base resources 410 and the virtual resources 420; an xpath generation table 384; and a temporary configuration XML 385.

Each time the configuration information DB 365 is updated, the configuration manager 360 notifies it to the monitoring system 100. Alternatively, a tree transformation configuration 381 that received a tree transformation request 373 inputted from the terminal 350 of FIG. 1 generates configuration information (a configuration information XML 386) in an XML format from the configuration information stored in the configuration information DB 365 with reference to a relationship between the system components stored in the baseline configuration table 383 using the xpath generation table 384 and the temporary configuration XML 385. The tree transformation configuration 381 sends this configuration information XML 386 and a configuration change request generation module 364 that receives this notifies it to the monitoring system 100 as the configuration information 245.

Upon reception of the notification from the configuration manager 360, the monitoring system 100 updates the assigned ID management table 160, the configuration information management table 130, etc.

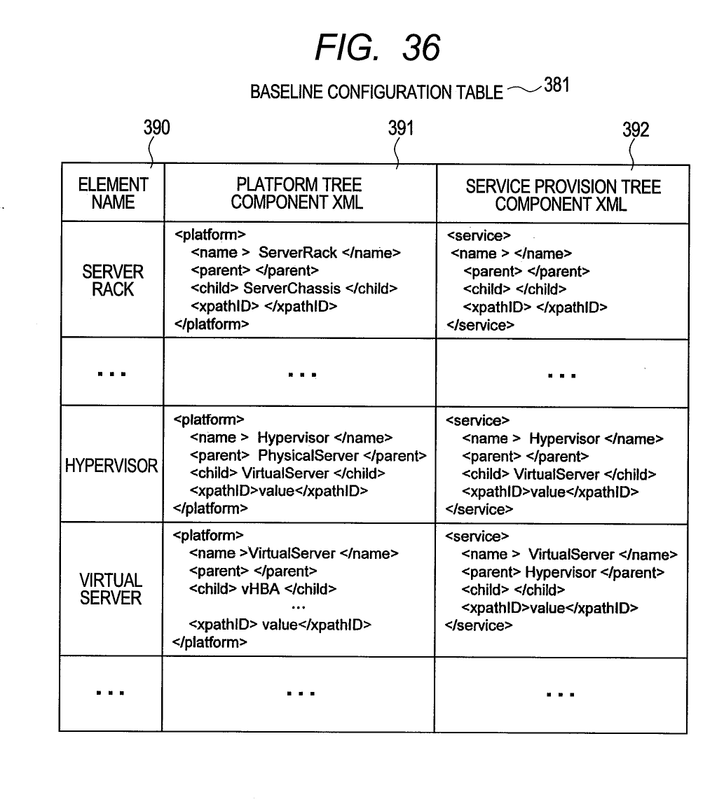

The baseline configuration table 383 and the xpath generation table 384 stores a definition of a parent-child relationship of each component of two pieces of data (trees) that will be described later and a definition for classifying the trees for the components of the monitored resources described above (the base resources 410 and the virtual resources 420). Any element stored in the baseline configuration table 383 is basically configured by an administrator from an input device etc. of the terminal 350. Alternatively, in the case where a data type of acquired configuration information 375 is defined by a type (FIG. 36) of the baseline configuration table 383, the acquired configuration information 375 is stored in the baseline configuration table 383. When the configuration manager 360 receives a baseline configuration input 382 for defining the components of the platform tree 600 and the components of the service provision tree 610 from the terminal 350, it updates the baseline configuration table 383.

Incidentally, it is also possible for the monitoring system 100 to refer to or update the baseline configuration table 383, the xpath generation table 384, and the temporary configuration XML 385. Moreover, the monitoring system 100 may hold duplicates of the baseline configuration table 383, the xpath generation table 384, and the temporary configuration XML 385 in the monitor information database 110.

The baseline configuration table 383 defines a tree structure of a parent node and a child node of the platform tree 600 and a tree structure of the parent node and the child node of the service provision tree 610, respectively.

The xpath generation table 384 and the temporary configuration XML 385 are used when the monitoring system 100 generates the platform tree 600 and the service provision tree 610. The generation of the platform tree 600 and the service provision tree 610 will be described later.

The configuration manager 360 controls the server virtualization module 421 to allocate the physical resources to the virtual resources 420. That is, the configuration manager 360 specifies the monitored resources 400 (computer resources) of the physical server 411 and the storage device 450 that are to be assigned to the virtual server 422 to the server virtualization module 421.

Moreover, the configuration manager 360 controls the operational condition of the physical server 411. The configuration manager 360 instructs the virtualization module 421 of the monitored resource c 400 to generate, delete, or move the virtual server 422 (a configuration change instruction including the configuration information and the configuration information generation policy) and controls the virtual server 422 of the each physical server 411. Moreover, the configuration manager 360 notifies the configuration information 245 of the configuration change instruction that was instructed to the monitored resources 400 and the configuration information generation policy 240 to the monitoring system 100.

In the case where the monitored resources 400 that the monitoring system 100 monitors is built up in advance, the administrator inputs a configuration acquisition request 372 to the configuration manager 360, makes a configuration acquisition request generation module 371 generate a configuration acquisition command 374, and issues it to the monitored resources 400. As one of embodiments of the configuration acquisition command 374, there is enumerated a standard interface for operations management of the system like SNMP, CIM and SMI-S, and SMASH.

When the configuration manager 360 receives the acquired configuration information 375 that is an acknowledge from the monitored resources 400 as an acknowledge of the configuration acquisition command 374, it is inputted into the configuration change request generation module 364, and gets stored in the configuration information DB 365. Moreover, in the case where the data type of the acquired configuration information 375 is the same type as that of the baseline configuration table 383 (FIG. 36), installation such that the acquired configuration information 375 is also inputted into the baseline configuration table 383 may be performed.

The acquired configuration information 375 that is an acknowledge from the monitored resources 400 to the configuration acquisition command 374 is stored in the configuration information DB 365 by the configuration change request generation module 364. Next, the configuration change request generation module 364 makes a request to the tree transformation configuration 381 to generate the configuration information XML, and the tree transformation configuration 381 generates the configuration information XML 386 using the configuration information DB 365, the baseline configuration table 383, the xpath generation table 384, and the temporary configuration XML 385. Next, the configuration change request generation module 364 sends Configuration Information XML 386 to a configuration change information transmission module 362 as configuration information after change 245y, and the configuration change information transmission module 362 transfers it to the configuration information relation management module 230 as the configuration information 245. At this time, as to configuration information before change 245x, “null” data is passed. In the configuration information relation management module 230, the data is stored in the configuration information management table through the configuration information management module 200 of FIG. 2.

In the case of the configuration information that cannot be automatically collected by the configuration acquisition command 374, for example, a shelf for storing an information processing device or the like, such as a rack mount having no operations management mechanism, the administrator inputs it directly into the configuration manager 360 through a configuration input 3720 or the baseline configuration input 382.

The configuration manager 360 includes: a configuration change request processing module 361 that accepts a configuration change request 366 to the monitored resources 400 from an unillustrated I/O device of the terminal 350 and, when the configuration change request 366 is completed, outputs a configuration change completion notification 367 to the I/O device; a configuration information database 365 for storing the configuration information of the monitored resources 400; a configuration change request generation module 364 for generating the configuration information before change 245x, the configuration information after change 245y, and a generation policy 240 of the configuration information based on the configuration information of the configuration change request processing module 361 and the configuration information database 365 from the configuration change request processing module 361; a configuration change information transmission module 362 that designates the configuration information before change 245x and the configuration information after change 245y as the configuration information 245, transmits the configuration information generation policy 240 and the configuration information 245 to the configuration information relation management module 230 and a configuration change direction module 363 of the monitoring system 100; and the configuration change direction module 363 for transmitting the configuration change request 366 to the server virtualization module 421 of the monitored resources 400 based on the configuration information generation policy 240 and the configuration information 245.

The configuration information database 365 has the same configuration as those of the platform tree 600 and the service provision tree 610 of the configuration information management table 130 shown in FIG. 4 described later. However, the configuration information database 365 does not have the component IDs about the components contained in configuration information 500 (a generic term of configuration information XMLs 500a-500c) of the configuration information management table 130. Regarding the component ID, when the configuration information relation management module 230 of the monitoring system 100 receives the new configuration information 245, it gives the new component ID.

When the configuration manager 360 accepts the configuration change request 366 from the I/O device (illustration abbreviated) of the terminal 350, it accepts the policy included in the configuration change request 366, the (current) configuration information before change 245x, and the configuration information after change 245y, and transmits the configuration information 245 and configuration information generation policy 240 to the monitoring system 100 and the monitored resources 400.

Then, when the processing of the configuration change request processing module 361 is completed, the configuration manager 360 outputs the configuration change completion notification 367 to the I/O device, and updates the configuration information database 365 with the new configuration information 245y.

Moreover, the component ID given to the component of the configuration information 500 in the configuration information management table 130 is a value that the configuration information relation management module 230 gives and is unique within the monitoring system 100. This component ID is a unique identifier that the configuration information relation management module 230 allocates to each component of the configuration information regardless of the tree structure of the components that constitute the configuration information 500. Regarding the component ID, a unique value is assigned to each of the components of the base resources 410 that are components of the monitored resources 400 and the components of the virtual resources 420.

That is, while the component of the monitored resources 400 is hierarchical information that is comprised of the tree structure, the component ID functions as a unique identifier within the monitoring system 100. The component ID is assigned to each of the components of the base resources 410, each of the components of the virtual resources 420, and the performance statistics, respectively, like the assigned ID management table 160 that will be described later. When executing change of the component, such as migration, it becomes to combine the performance statistics related with the component between before and after the configuration change by the component that is subjected to the configuration change inheriting this component ID.

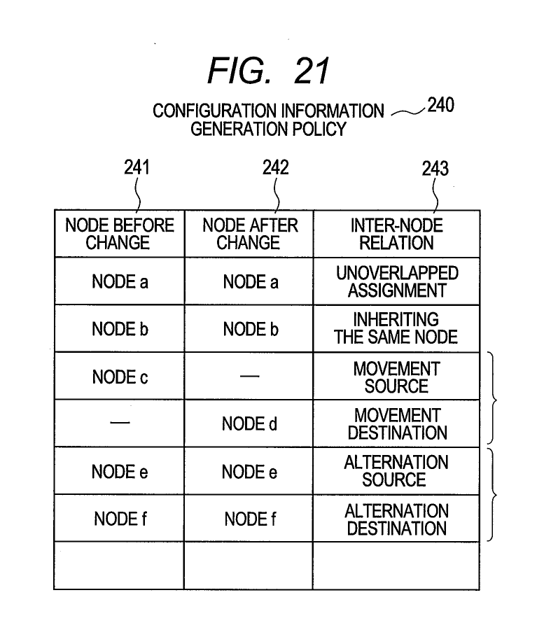

FIG. 21 is an explanatory diagram showing one example of the configuration information generation policy 240 that the configuration change request generation module 364 of the configuration manager 360 outputs. The configuration change request generation module 364 extracts a relationship of information between the node (partial tree) of the configuration information before change and the node of the configuration information after change from the configuration change request 366 accepted from the configuration change request processing module 361, and generates the configuration information generation policy 240 by designating the node of the configuration information before change as a node before change 241, designating the node of the configuration information after change as a node after change 242, and designating the relationship among nodes as inter-node relation 243.

The inter-node relation 243 is classified into “unoverlapped assignment,” “inheriting the same node,” “movement source,” “movement destination,” “change source,” “change destination,” etc.

The inter-node relation 243 of “unoverlapped assignment” is a case where the single virtual server 422 is used being switched between day and night, or like cases. In such a case, the configuration manager 360 instructs the monitoring system 100 to allocate the component IDs so that they may be not overlapped between pieces of configuration information whose nodes to be altered are the same and to which different configuration information IDs (162) are assigned. The example of illustrated “unoverlapped assignment” shows that the component of a node “a” is switched and a new component ID is given to the component of the node “a” after the change.

The inter-node relation 243 of “inheriting the same node” of FIG. 21 is a case where the component is not altered, and the example of illustration indicates that the node “b” inherits the same component ID between before and after the configuration information change. Moreover, the inter-node relation 243 of “movement source” and “movement destination” is a case where the node moves, and the example of illustration indicates that a node “c” of the movement source moves as a node “d.” In this case, the monitoring system 100 gives the component ID of the configuration information assigned to the node “c” to the node “d” as the component ID thereof in the configuration information after the change.

The inter-node relation 243 of “alternation source” and “alternation destination” is for a case where system switching is done between a current system and a standby system, and an illustrated example shows that the node e denotes the alternation source and the component is moved to the node f. In this case, the monitoring system 100 overwrites the component ID of the component assigned to the node e with the component D of the component assigned to the node f.

### <Outline of Configuration Change Processing>

One example of a processing performed by the computer system of FIG. 1 is shown below.

Each time the configuration manager 360 alters the configuration of the monitored resources 400, it notifies the monitoring system 100 of the configuration information 245, the configuration information generation policy 240, and the baseline configuration table 383. The monitoring system 100 updates the platform tree 600 and the service provision tree of the configuration information management table 130 from the configuration information 245, the configuration information generation policy 240, and the baseline configuration table 383 that are notified.

Upon acceptance of new configuration information, for example, the monitoring system 100 adds the content of the configuration information 245 (e.g., the physical server 411, the virtual server 422, or the I/O device) to the configuration information XML of configuration information 134 in the configuration information management table 130, and allocates a component ID 161 unique within the computer system to every component contained in the configuration information XML.

On the other hand, when a collection request of the operation information on the monitored resources 400 is transmitted from the terminal 350 to the performance statistics collector 300, the performance statistics collector 300 stores a definition regarding collection of the operation information to the requested monitored resources 400 and the statistics of the operation information (the performance statistics), and give the statistics IDs to the statistics. The performance statistics collector 300 correlates the configuration information ID, the performance statistics (a CPU utilization, a memory utilization, etc.), and the statistics ID of the monitored resources 400 that has become a collection target of the statistics of the operation information, and notifies them to the monitoring system 100.

The monitoring system 100 accepts the configuration information ID and the statistics ID from the performance statistics collector 300, and stores the statistics ID and the performance statistics in the configuration information XML of a relevant record of the platform tree 600 and the service provision tree 610 of the configuration information management table 130. Thereby, the component ID and the statistics ID that are the identifiers unique within the monitored resources 400 are related with each other.

Next, when the configuration manager 360 moves the virtual server 422, the monitoring system 100 accepts the configuration information 245 and the configuration information generation policy 240 from the configuration manager 360, and if the content of the configuration information generation policy 240 is “alternation (alternation source, alternation destination),” the component ID of the movement source specified by the configuration information 245 and the statistics ID being made related with the component ID are made to be inherited to the component ID of the configuration information of the movement destination. Thereby, the statistics IDs being made related with the component IDs are also inherited by the movement destination of the configuration information. Moreover, in the configuration information management table 130, an change history of the configuration information is recorded as a revision.

The performance statistics collector 300 monitors the monitored resources 400 at a predetermined timing, collects specified operation information, and stores the performance statistics obtained by performing a predetermined statistical processing on the operation information in the performance statistics table 120 of the monitoring system 100 together with the statistics ID. The timing at which the performance statistics collector 300 monitors the monitored resources 400 is defined by a monitor interval 314 of a configuration information collection parameter 310. Incidentally, the statistical processing is a processing of generating the performance statistics, such as calculation of an average, maximum or minimum, a standard deviation, etc. on the operation information by performing predetermined statistical processings.

When the terminal 350 requires the performance statistics of the monitoring system 100, the monitoring system 100 retrieves the component ID of the specified configuration information from the configuration information management table 130, and acquires the statistics ID related with the component ID. Then, the monitoring system 100 acquires the performance statistics corresponding to the statistics ID from the performance statistics table 120, and outputs it to the terminal 350.

Even if the virtual server 422 is moved between the physical servers 411, if the inter-node relation 243 of the configuration information generation policy 240 is “inheriting the same node” or the like, the component ID and the statistics ID are inherited by the configuration information (configuration information XML) 134 of the movement destination as it is; therefore, it becomes possible to display the performance statistics corresponding to the statistics ID of the virtual server 422 in the terminal 350, crossing over before and after the movement. Moreover, when the terminal 350 requires the history of the configuration information of the monitoring system 100, the history of the configuration information before and after movement of the virtual server 422 can be outputted to the terminal 350.

Below, the components and their operations of the monitoring system will be explained using drawings.

### <Various Tables in Monitor Information Database>

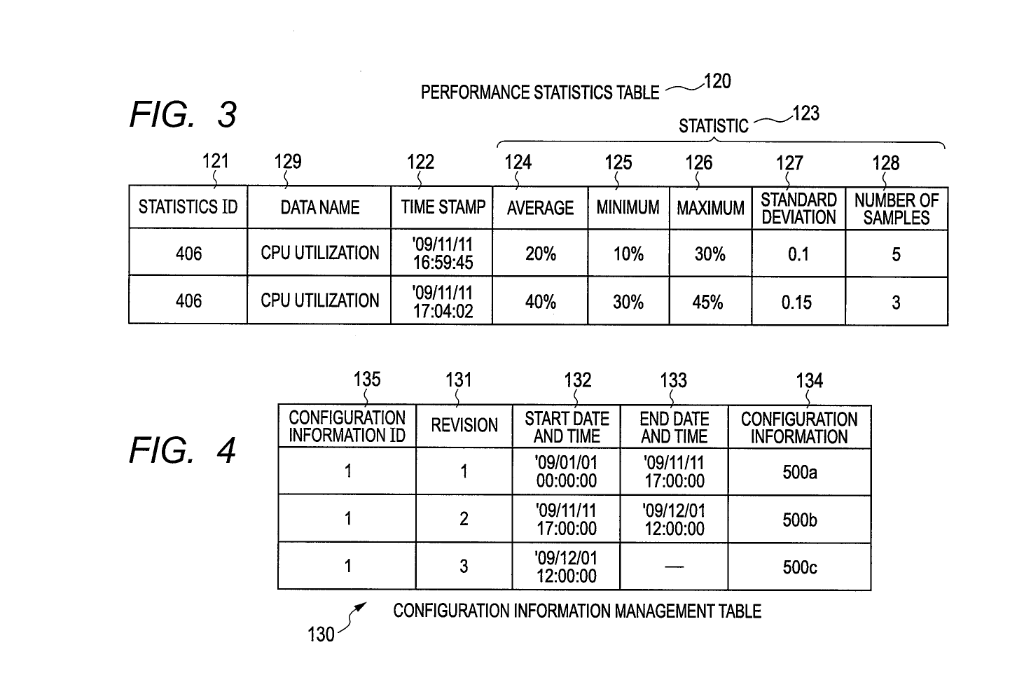

FIG. 3 is a composition example of the performance statistics table 120. It is a table for storing the statistics (the performance statistics) 123 that the performance information management module 190 manages. Each record includes data name 129, statistics ID 121, time stamp 122, and one or more statistics 123. Although average 124, minimum 125, maximum 126, standard deviation 127, and number of samples 128 are selected here as the statistics 123, a part of them may be sufficient or it may be represented by performance statistics other than these.

The performance statistics table 120 stores the statistics of the operation information of the monitored resources 400 that the performance statistics collector 300 collected as will be described later. The statistics 123 have a module having been configured in advance for every statistics ID, and the modules include utilization (%) of the processor, utilization of the memory (GB), a data transfer quantity (I/O traffic: GB/sec) of the interface per module time, etc., for example.

FIG. 4 shows a composition example of the configuration information management table 130 of the monitoring system 100. The configuration information management table 130 is a table of the monitor information database 110 that accumulates the configuration information 245 received from the configuration manager 360, and stores the history (revision) of the configuration information that the configuration manager 360 manages. When the monitoring system 100 is started, it receives the configuration information database 365 from the configuration manager 360, and stores the configuration information 245 of the current monitored resources 400 in the configuration information management table 130.

Each record of the configuration information management table 130 is comprised of the following fields: configuration information ID 135; revision 131; start date and time 132; end date and time 133; and configuration information 134. Here, although various techniques of managing Configuration Information 134 are considerable, there can be considered, for example, a method whereby the configuration information data 500 in the XML format is generated and a link and a filename to the configuration information data are registered in the fields of Configuration Information 134. Naturally, the configuration information data in the XML format is also storable in the field of Configuration Information 134. Incidentally, a record such that a value of the end date and time 133 is “-” or NULL indicates the newest configuration information.

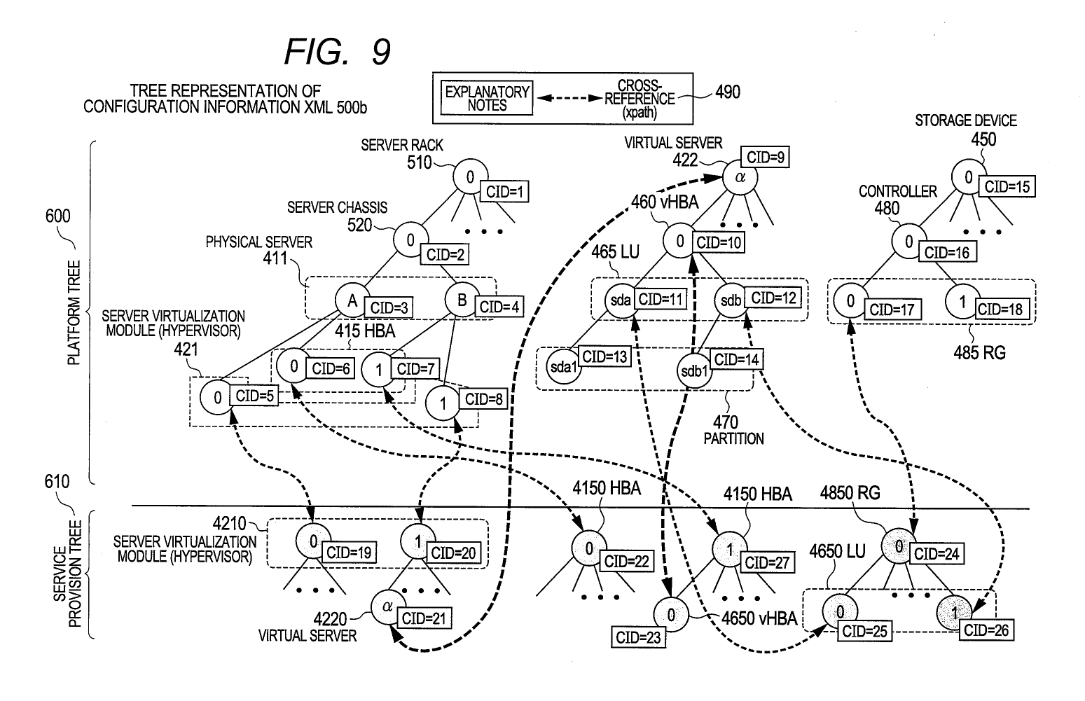

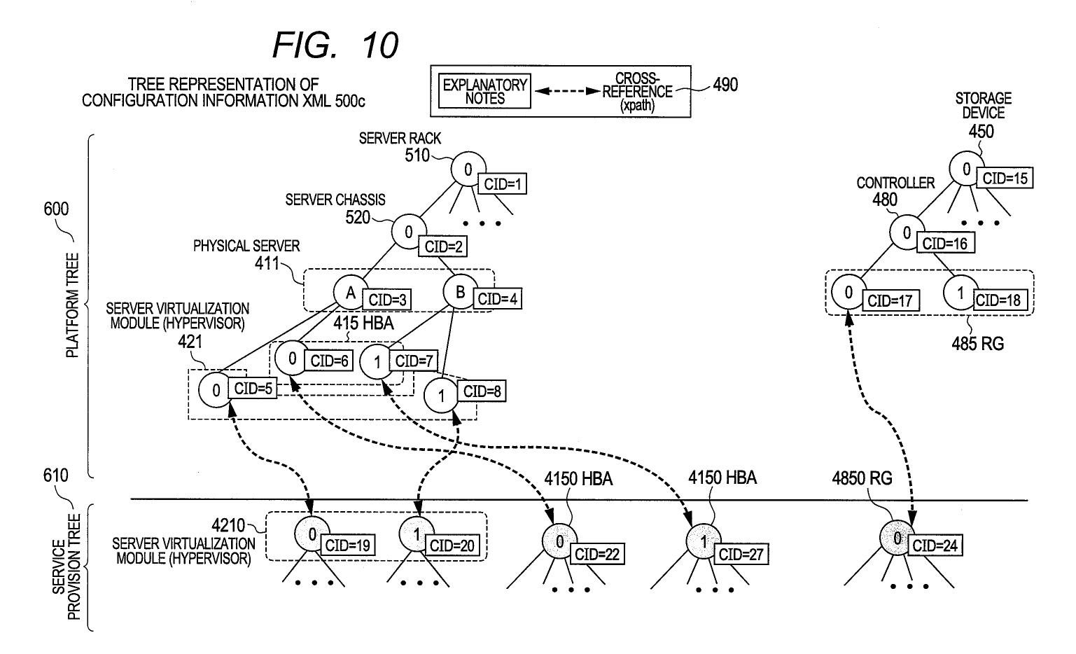

Although, in the example of FIG. 4, the configuration information of three revisions 131 is registered to the configuration information that is the configuration information ID 135=1, and the end date and time 133 is configured in records of the revision 131=1 and the revision 131=2; the end date and time 133 is not configured in a record of the revision 131=3 (“-”), which indicates that the configuration information of the revision 131=3 is a revision currently being used (the newest). The configuration information XMLs 500a, 500b, and 500c that correspond to the respective revisions are shown in FIG. 8, FIG. 9, and FIG. 10, respectively, that will be described later. However, in FIG. 8, FIG. 9, and FIG. 10, in order to simplify the explanation, the configuration information related to the performance statistics of the operation information is omitted.

The monitoring system 100 accepts the configuration information 245 from the configuration manager 360, and stores the configuration information of the monitored resources 400 in the configuration information management table 130 for each generation (revision). The configuration information management table 130 and the configuration information database 365 of the configuration manager 360 are the same configuration as described above. For this reason, having generated new configuration information 245y, the configuration manager 360 generates the new configuration information ID 135 and a revision 131=1.

Incidentally, in the case where the history (generation) of the configuration information of the monitored resources 400 is not managed by the configuration manager 360, the configuration information management module 200 of the monitoring system 100 just has to manage the revision 131. In this case, when the configuration information management module 200 accepts new configuration information 245 to the same configuration information ID 135, it configures a value obtained by incrementing the current revision 131 in the revision 131 of a record for storing new configuration information as a value indicating the newest generation.

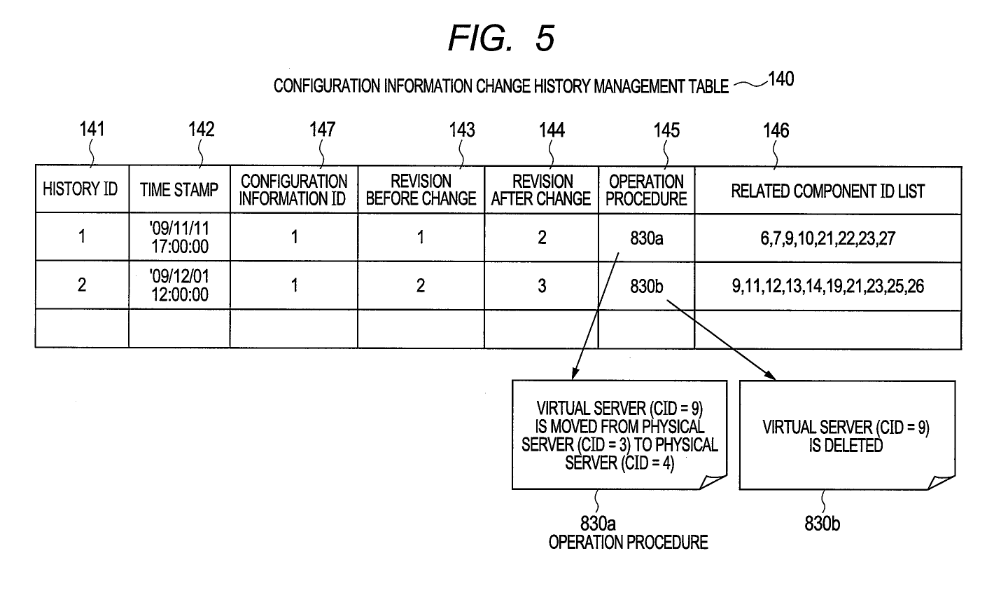

FIG. 5 is a composition example of the configuration information change history management table 140. The configuration information change history management table 140 stores a history (revision) of the configuration information that the history information management module 210 of the monitoring system 100 manages. Each record includes fields of history ID 141, time stamp 142 at the time when the configuration change takes place, configuration information ID 147, revision before change 143, revision after change 144, link 145 to the operation procedure 830, and related component ID list 146.

The history ID 141 is a value that the configuration information management module 210 configures and is given a unique identifier. The operation procedure 145 is a text string or a pointer to the text string that outputs what change has been done at the time of configuration information change to the terminal 350 and that makes it easier for the administrator or user to understand by seeing it. There are considerable a method for generating it automatically from a difference of the configuration information, a method whereby the administrator is made to input it as a comment at the time of instructing the configuration change by the configuration manager 360, etc. The related component ID list 146 is a list of the component IDs affected by relevant configuration change.

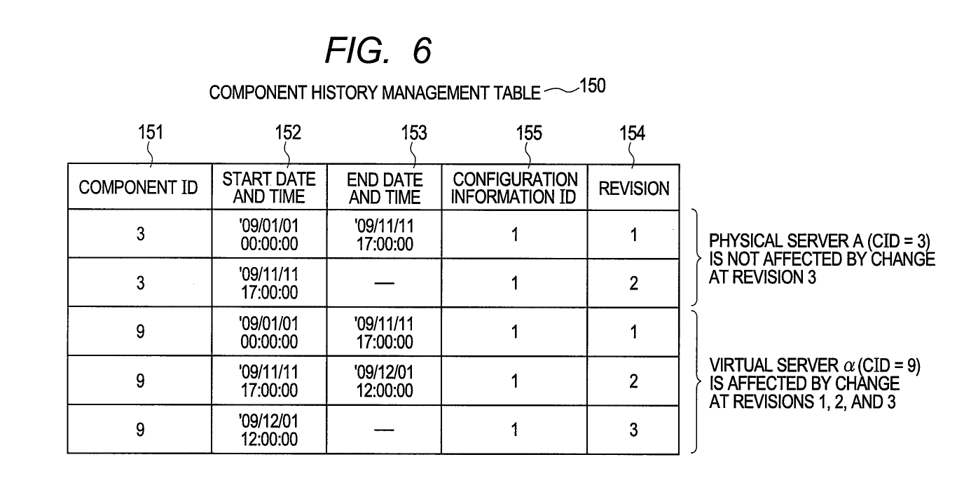

FIG. 6 is a composition example of the component history management table 150. The component history management table 150 is a table that the history information management module 210 of the monitoring system 100 manages and in which a record is registered only with respect to component ID 151 affected by the configuration change.

Each record includes fields of the component ID 151, start date and time 152 of a new configuration, end date and time 153 of the configuration, configuration information ID 155, and revision 154. The record such that a value of the end date and time is “-” or NULL indicates that the revision is the newest.

In an example of FIG. 6, although the component whose Component ID 151 is “3” is affected by an influence when the revision 154 is altered from “1” to “2,” it is not affected by an influence of the configuration change when the revision 154 is altered from “2” to “3”; therefore, the revision 154=2 is the newest. On the other hand, since the component whose component ID 151 is “9” is affected by two configuration changes, the revision 154=3 is the newest.

### <Tree Representation of Configuration Information XML>

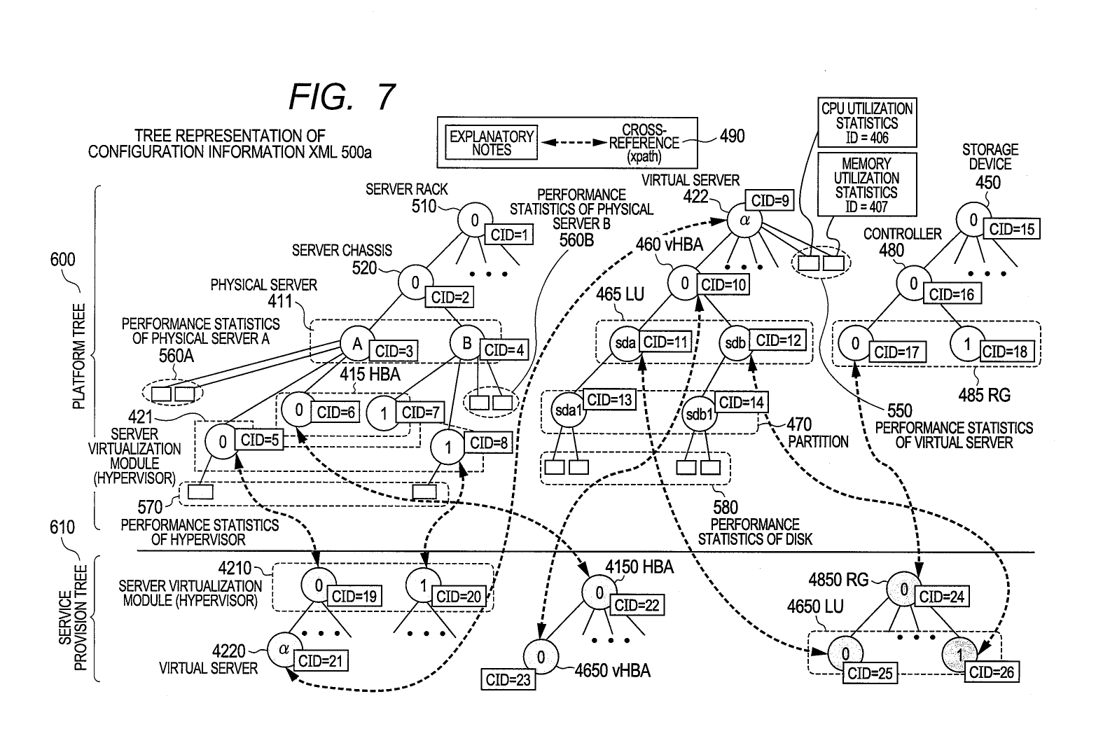

FIG. 7 is a diagram that excerpts a part of a tree representation of the configuration information XML 500a stored in Configuration Information 134 in the configuration information management table 130. The example of FIG. 7 is an example that represents Configuration Information 134 of the revision 131=1 shown in FIG. 4 by a tree (partial tree).

The configuration information is divided into two kinds of data structures, the platform tree 600 and the service provision tree 610.

The platform tree 600 is data that represents a connection relationship of the system components existing in a space that is closed by a certain one kind of phase boundary called “platform” like a system configuration having the physical resources as main constituents and a configuration having virtual resources as main constituents. In other words, the platform tree 600 is data of the tree structure that analyzed the connection relationship of the components for every category (platform) of the computer resource.

On the other hand, the service provision tree 610 is data representing the connection relationship of one or more components into which one certain computer resource is divided virtually (or logically). In other words, the service provision tree 610 is data of a tree structure having virtual resources that a client computer (illustration abbreviated) using the monitored resources 400 can identify in the child nodes and represents the relationships between the child nodes and the parent node of the platform tree 600.

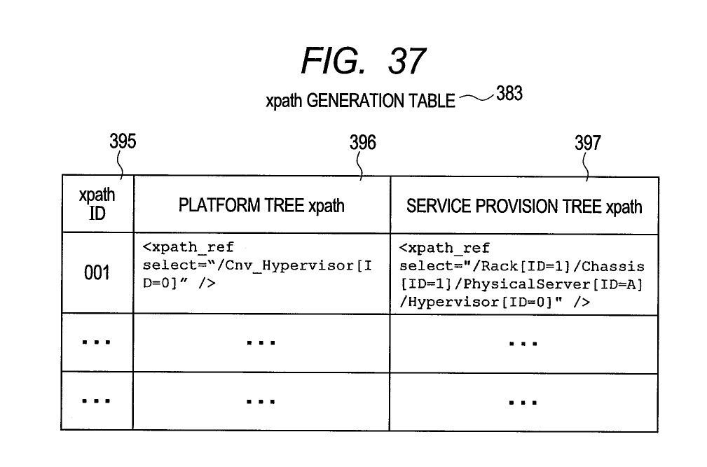

The connection relationship of the component of the platform tree 600 and the parent node of the service provision tree 610 is shown by cross-reference 490 (broken line in the figure). The cross-reference 490 is data indicating the connection relationship between a parent attribute (described as parent in FIG. 36) element and a child attribute (described as child in FIG. 36) element both defined by the baseline configuration table 383, and is represented by data of a platform tree xpath 396 and a service provision tree xpath 397 of the xpath generation table 383 of FIG. 37. Incidentally, the parent attribute becomes a higher-rank element, and the child attribute becomes a lower-rank element.

Incidentally, in the case where a client computer that uses a virtual server 4222 through the network 430 exists, virtual resources that the client computer accesses, such as the virtual server 422, the OS 423, and the Lu 465, are included in the service provision tree 610. In other words, it is possible to treat any computer resource identifiable from the client computer that a user of the virtual server 422 uses as the service provision tree 610.

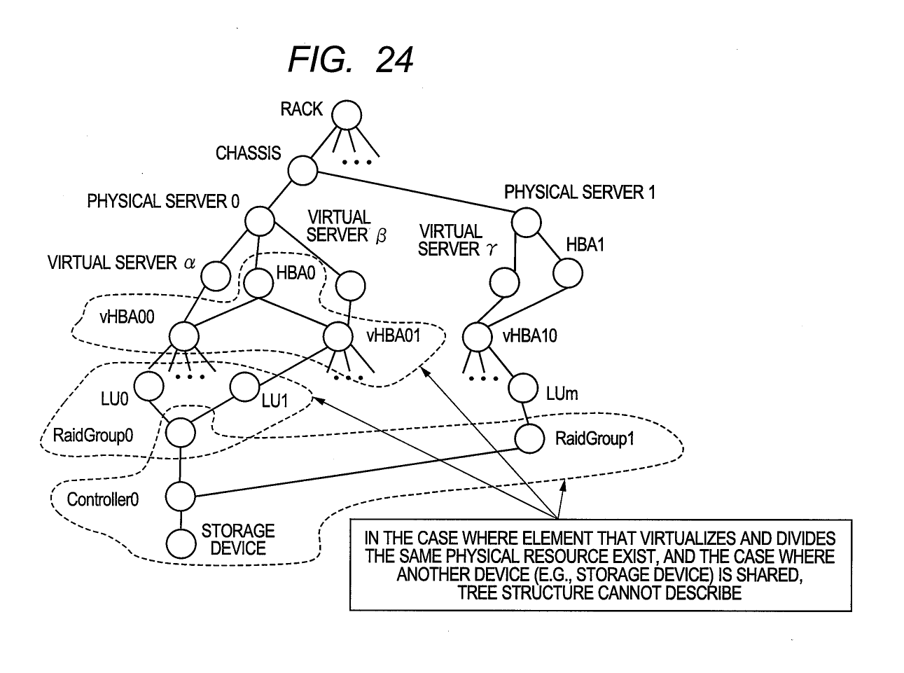

An overall configuration of the monitored resources 400 is represented by connecting the platform tree 600 and the service provision tree 610 with the pointer (or reference information) of the cross-reference 490. A reason of putting the components of the computer resources (the base resources 410 plus the virtual resources 420) into separate tree structures whose purports are different will be shown using FIG. 24.

FIG. 24 is an explanatory diagram of an example of representing a configuration diagram of a computer system (monitored resources 400) to which virtualization is applied using nodes (vertexes) and edges (sides). As in FIG. 24, if a virtualized computer system is represented by a graph, the graph does not take a tree structure, and therefore it is difficult to manage the configuration by the XML format. For example, if disk partitions (LU0 and LU1 of FIG. 24) connected to the virtual servers α, β are logically separated, they are constructed physically on the same RAID (RG0 of FIG. 24). For this reason, if the computer system is represented by the tree structure, it will become impossible to judge which virtual resources are developed on the same physical resource like LU0, LU1 of FIG. 24. That is, in FIG. 24, although LU0 and LU1 exist in the RaidGroup0 of the storage device, the virtual HBA (vHBA) accessing LU0 has two paths: a path connected to HBA0 that is a physical I/O device; and a path connected to the virtual server α. Therefore, it is difficult to represent it as data of the tree structure.

In the case where an excessive load is imposed on an LU connected to a certain virtual server in this virtual computer system, for example, in the case where total retrieval is exerted on a database, it may happen that the another virtual server using other LU being developed on the same RG goes down in performance without any previous sign of failure. In order to conduct a diagnosis of such a situation quickly, it is necessary to be able to grasp correctly the relationship between the base resources 410 including the physical resources and the virtual resources 420. An efficiency of the diagnosis is improved by cutting out and managing portions that are divided from one set of base resources into one or more virtual resources 420 and are used. On the other hand, in the case of actual system construction of the virtual server, any operation of dividing the physical resource logically is certainly defined as one work. For example, an operation of building a virtual machine by operating the hypervisor is enumerated. Because of a fact that such a work of virtualization can be cut out separately, Cutting out and managing a portion that is virtualized even on the data structure representing the configuration information produces an advantage that matching with an actual work is easy to understand and it is easy for the administrator to grasp an image of a management work using a monitoring tool.

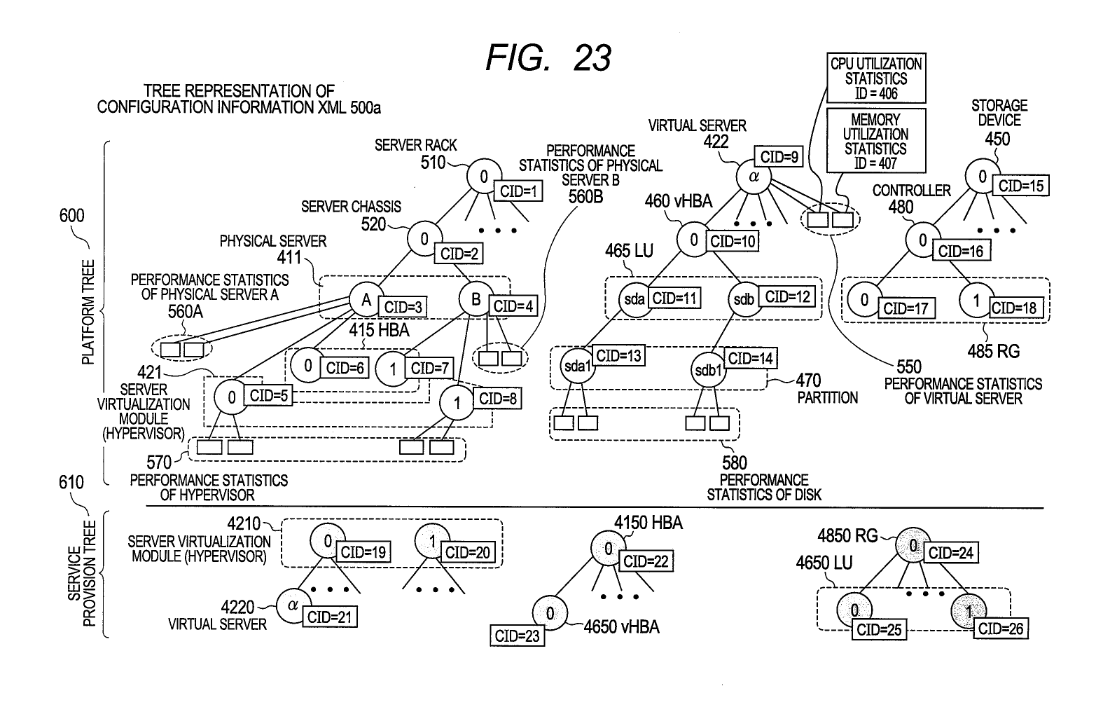

FIG. 23 shows the components of the monitored resources 400 such that only the data of the tree structure is extracted from FIG. 7. In the platform tree 600, a tree that represents the physical server as a platform by allocating the server rack 510 as a root node, a tree that represents the virtual server as a platform, and a tree that represents the storage device as a platform are defined separately.

Definitions of the components that become the parent node and the child nodes in the platform tree 600 are defined by the baseline configuration table 383 of the configuration manager 360. The baseline configuration table 383 is comprised of pieces of definition information showing the parent-child relationships of the monitored resources 400 that the administrator etc. configures on the terminal 350, as shown in FIG. 36.

In FIG. 36, one record is comprised of element name 390, platform tree component XML 391, and service provision tree component XML 392 in the baseline configuration table 383.

In the element name 390, a name (or identifier) of the component of the monitored resources 400 is stored. In the platform tree component XML 391, the component that acts as the child node is set to be in <child>. In the case of the component that acts as the parent node in the service provision tree 610, the component of the element name concerned is set to be in <parent>. In the service provision tree component XML 392, the component that acts as the parent node is set to be in <parent>, and the component that acts as the child node is set to be in <child>.

For example, in FIG. 36, Element Name 390=“server rack” indicates that “SeverChassis” is set to be in <child> in Platform Tree Component XML 391, and the child node is the server chassis 520. Then, null is set in <parent> of the platform tree component XML 391, which indicates that the parent node is a non-existing root node. Moreover, since all the components of the service provision tree component XML 392 are null, the element name 390=“server rack” indicates that no component exist in the service provision tree 610.

On the other hand, the element name 390=“hypervisor” indicates that “PhysicalServer” is configured in <parent> of the platform tree component XML 391 and “VirtualServer” is configured in <child> thereof as <xpath>. Thereby, in the platform tree 600, it is indicated that the parent node of the hypervisor is a physical server and the child node thereof is a virtual server. Moreover, the service provision tree component 392 of the element name 390=“hypervisor” is such that “VirtualServer” is configured as <xpath> in <child>. Thereby, in the service provision tree 600, it is indicated that the hypervisor is the parent node, and the child node is the virtual server.

Then, a “value” defined by the platform tree component XML 391 and the service provision tree component XML 392 constitutes the cross-reference 490, and defines the connection relationship between the node of the platform tree 600 and the parent node of the service provision tree 610.

The platform tree 600 shown in FIG. 7 shows an example where the server rack 510, the virtual server 422, and the storage device 450 are defined as root nodes in the baseline configuration table 383 of FIG. 36, and a server virtualization module 4210, an HBA 4150, and an RG 4850 are configured as the parent nodes of the service provision tree 610. The connection relationship between each parent node of the service provision tree 610 and the child node of the platform tree 600 is defined by <xpath>.

Moreover, referring to the baseline configuration table 381 (FIG. 36) that will be described later, the monitoring system 100 extracts the parent node regarding configuration information specified by the input device of the monitoring terminal 350 based on a definition of the baseline configuration table 383 and generates the service provision tree 610. Regarding extraction of the parent node, being the parent node can be extracted when the element of the parent attribute takes null (described as <parent></parent> in FIG. 36) in each element of the baseline configuration table 381.

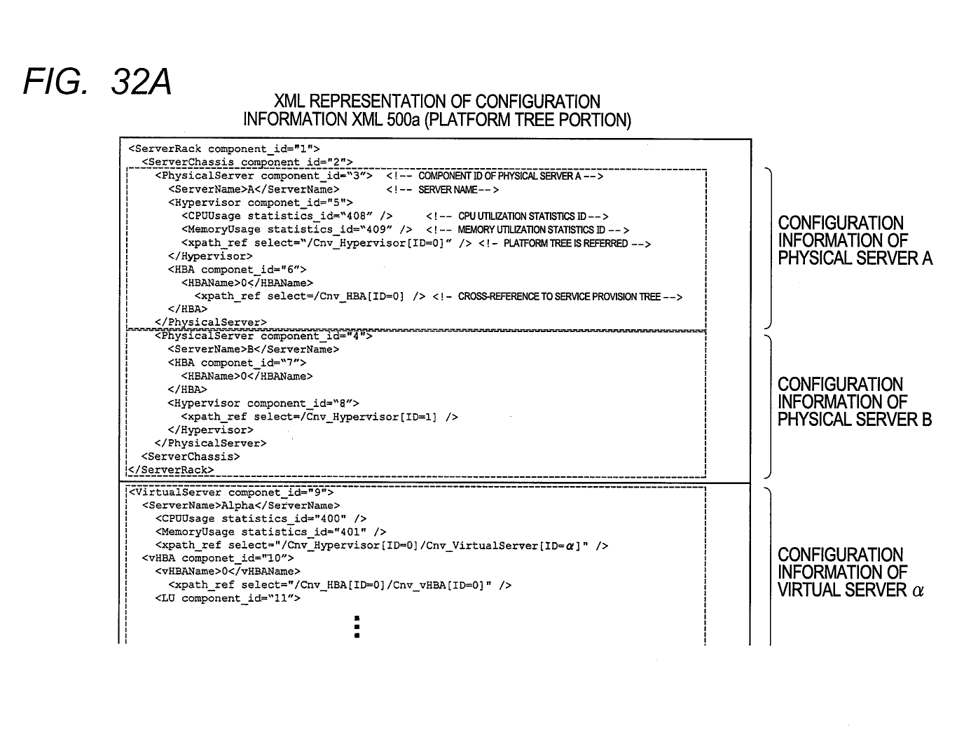

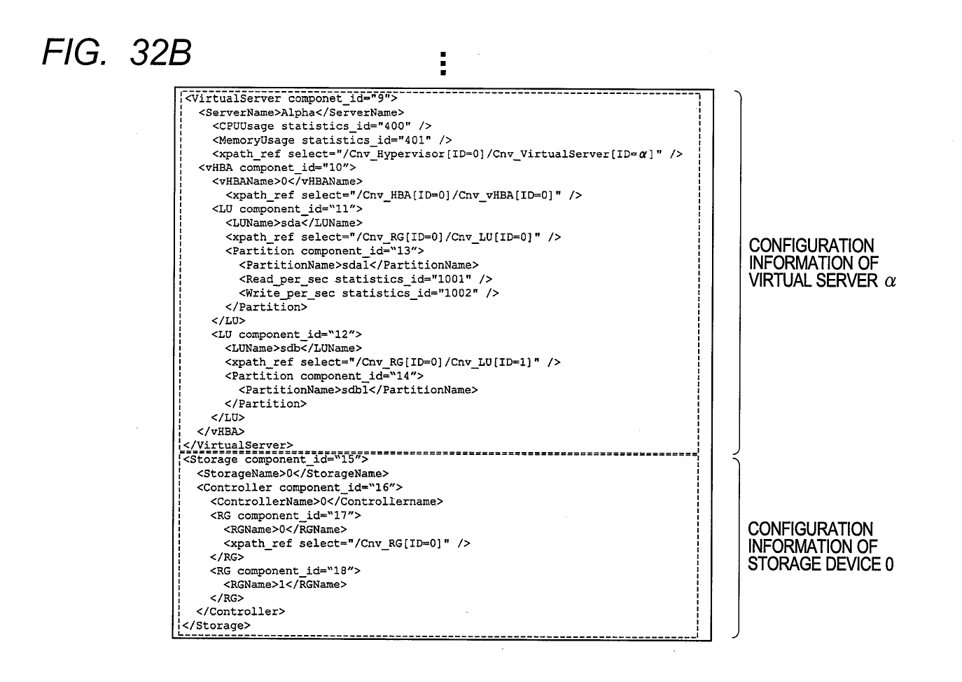

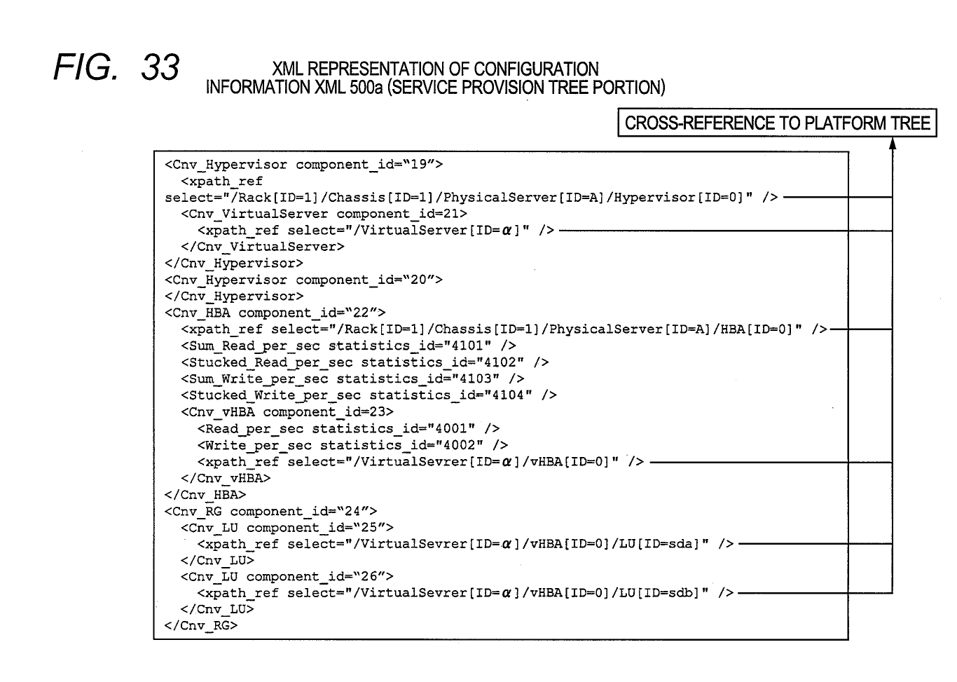

Incidentally, the platform tree 600 and the service provision tree 610 get stored in the configuration information management table 130 of the monitoring system 100 as XML information shown in FIG. 32A and FIG. 32B.

The tree showing the physical server as the platform of the virtualized environment shows a hierarchical relationship in which the server rack 510 serves as the parent node (vertex), the server chassis 520 that is stored in the server rack 510 exists in a lower rank thereof, the physical server 411 that is stored in the server chassis 520 in a lower rank thereof, the HBA 415 connected to the physical server 411 and the server virtualization module (hypervisor) 412 that is executed by the physical server 411 exist in a further lower rank thereof. Moreover, performance statistics 560A, 560B of the physical server 411 is related with a lower rank of the physical server 411. Furthermore, the performance statistics 570 of the hypervisor is related with a lower rank of the server virtualization module 421. Incidentally, the administrator etc. configures a configuration that the monitoring system 100 cannot identify, such as the relationship among the server rack 510, the server chassis 520, and the physical server 411 from the terminal 350.

The tree representing the platform of the virtual server shows the connection relationship in which the virtual server 422 is assigned as the parent node, a virtual HBA (vHBA) 460 is placed under the virtual server 422, the LU 465 is placed under the vHBA 460, and a partition 470 is placed under the LU 465. Pieces of performance statistics 550, such as the CPU utilization and the memory utilization of the virtual server 422 are made related with the virtual server 422. Furthermore, pieces of performance statistics 580, such as the throughput of a disk (LU), a queue length of an access request, and a busy rate of the disk, are made related with the partition 470.

The tree representing the platform of the storage device 450 indicates the connection relationship where the storage device 450 serves as the parent node, the controller 480 exists in a lower rank thereof, and the RG (RAID Group) 485 exists in a lower rank thereof.

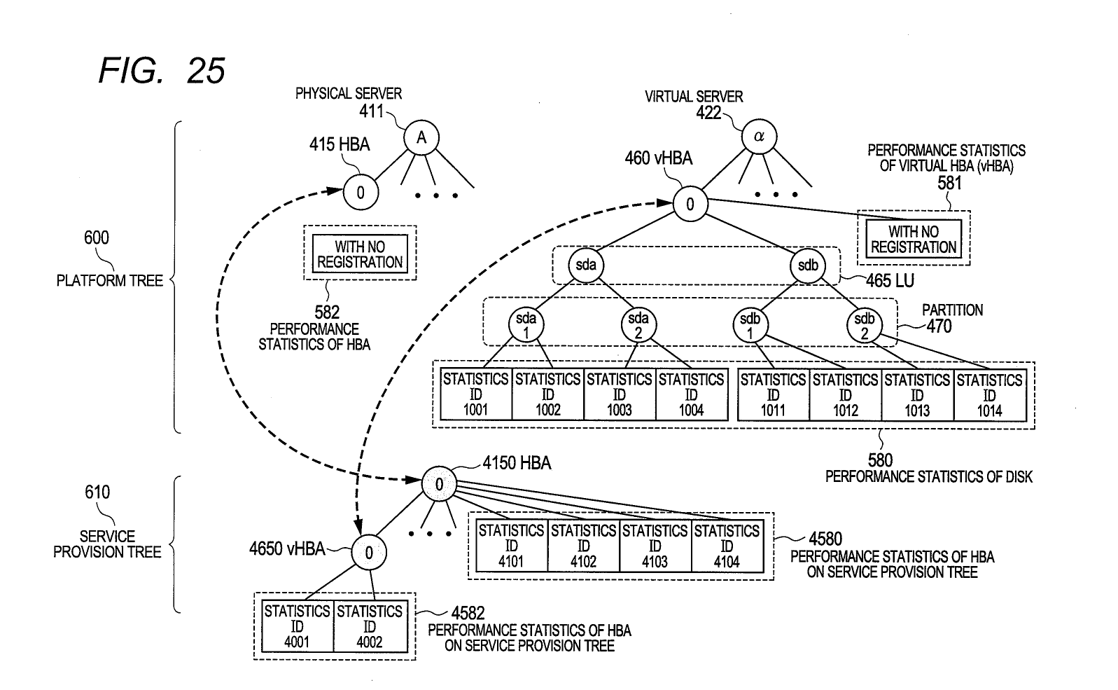

In the service provision tree 610, a tree of the components is generated from the parent-child relationship (the relationship between the parent attribute and the child attribute) defined for each element of the baseline configuration table 383. For example, in the service provision tree component XML 392 of FIG. 36, the component (XML description) existing in a row of “hypervisor of the element name 390 represents the server virtualization module (hypervisor) 4210 as the parent node, and under the hypervisor, the component (XML description) with the component name 390 existing in a row of “virtual server” is represented as a virtual server 4220. Moreover, the connection relationship of each node is represented by the parent attribute and the child attribute of each component XML. As in FIG. 25 described later, the performance statistics that exists in the platform tree 600 is also related with each component (each node that constitutes the tree) of the service provision tree 610.

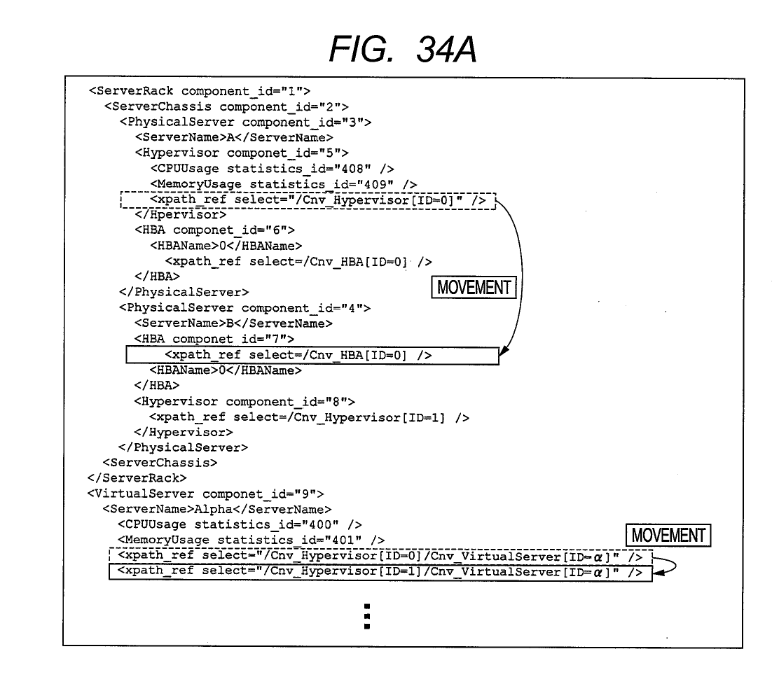

In the platform tree 600 and the service provision tree 610, the nodes that are related with each other by the cross-reference 490 (see explanatory notes of FIG. 7) as shown in FIG. 7 are mutually connected. In the data structure, the relation is done with the xpath shown in FIG. 32A, FIG. 32B, FIG. 33, and FIG. 36. Incidentally, the cross-reference 490 is given <xpathID> shown in FIG. 36, and this identifier enables the cross-reference 490 to be specified.

In FIG. 7, the server virtualization module 421 that is the child node of the platform tree 600 is referred to by the virtual server 4220 that is the child node of the service provision tree 610. Then, the virtual server 4220 that is the child node of the service provision tree 610 is referred to by the virtual server 422 of the platform tree 600. In addition, the virtual HBA 465 of the platform tree 600 refers to a virtual HBA (vHBA) 4650 that is the child node of the service provision tree 610, and the HBA 4150 that is the parent node of the vHBA 4650 refers to the HBA 415 of the platform tree 600. Moreover, the RG 485 that is the child node of the platform tree 600 is referred to by the RG 4850 that is the parent node of the service provision tree 610, and the LU 4650 that is the child node refers to the LU 465 of the platform tree 600.

Thus, it becomes possible to manage the relationships between the virtual server 422 and the base resources that the virtual server 422 uses without omission and using a small amount of time by virtue of the platform tree 600 and the service provision tree 610 of the present invention.

### <Generation of Configuration Information>

Next, generation of the configuration information XML 500a of FIG. 32A to FIG. 33 that provides the platform tree 600 and the service provision tree 610 will be explained below.

The configuration manager 360 generates the configuration information 500 from the components of the monitored resources 400 and the baseline configuration table 383, and stores it in the configuration information database 365. Then, the configuration manager 360 notifies the configuration information 500 to the monitoring system 100. The monitoring system 100 designates the configuration information 500 with the component ID added as the configuration information XML 500a and stores it in the configuration information management table 130. The configuration information XML 500a is classified into the platform tree 600 shown in FIG. 32A and FIG. 32B and the service provision tree 610 shown in FIG. 33.

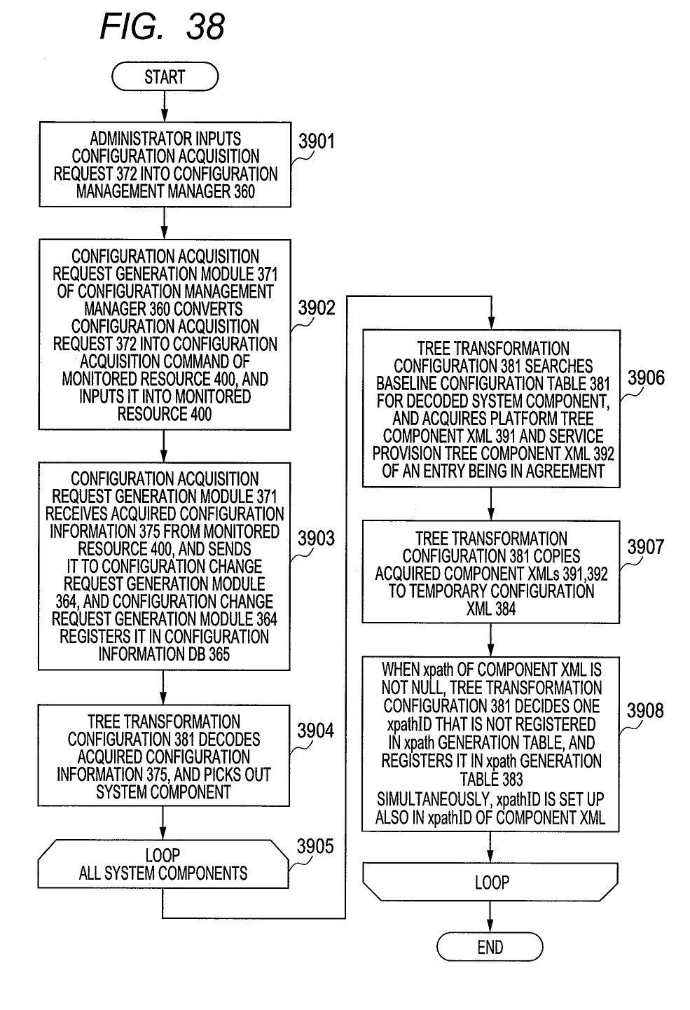

FIG. 38 to FIG. 41 are flowcharts showing one example of a generation processing of the configuration information 500 performed by the configuration manager 360.

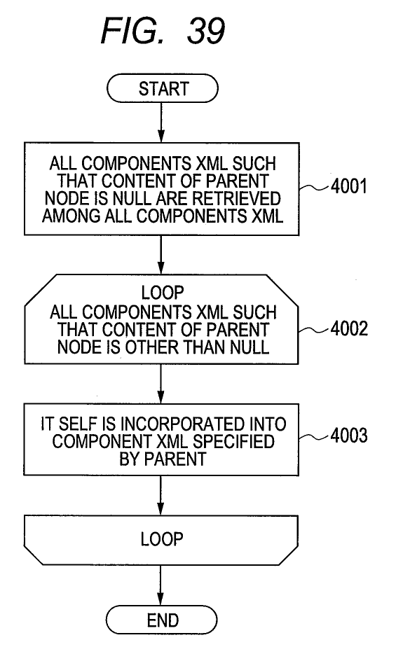

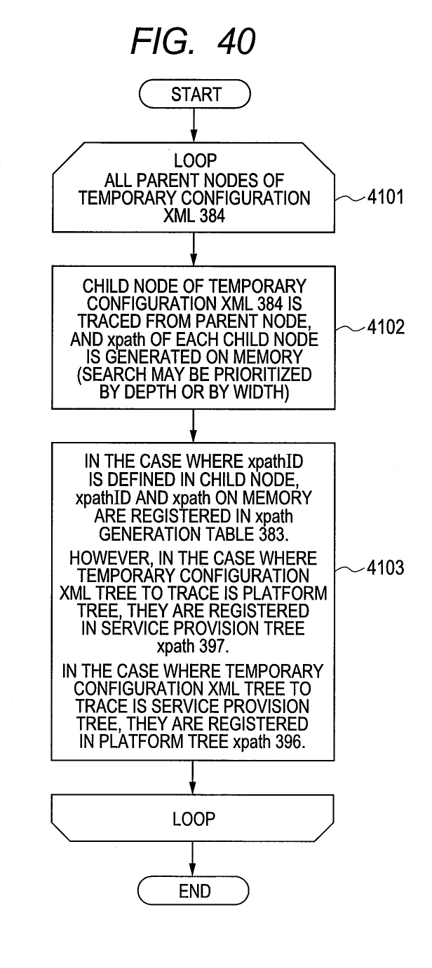

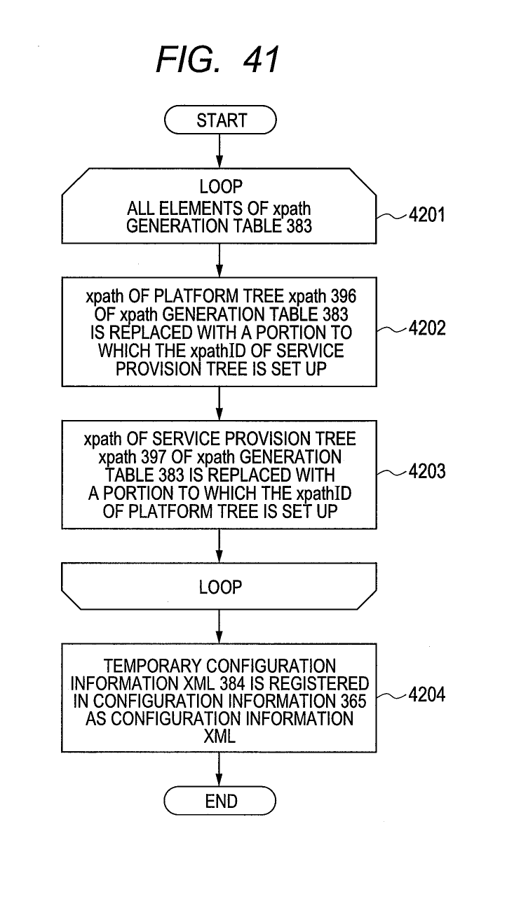

By an instruction from the terminal 350, the configuration manager 360 performs the flowchart of FIG. 38: it generates a temporary configuration XML 385, and configures the nodes of the platform tree 600 and the service provision tree 610 (node generation processing). Next, the configuration manager 360 performs the flowchart of FIG. 39: it generates tree structures of the nodes from the temporary configuration XML 385, respectively. Next, the configuration manager 360 performs the flowchart of FIG. 40: it extracts an xpath showing the cross-reference 490 between the platform tree 600 and the service provision tree 610 from the temporary configuration XML 385, and generates the xpath generation table 384 shown in FIG. 37. Finally, the configuration manager 360 performs the flowchart of FIG. 41: it generates the configuration information 500 by incorporating the xpath in the temporary configuration XML 385 from the temporary configuration XML 385 and the xpath generation table 384, and sends it to the monitoring system 100 as the configuration information 245. This configuration information 500 is stored in the configuration information management table 130. Moreover, the configuration information 500 may be registered in the configuration information database 365.

First, a node generation processing of FIG. 38 will be explained. The configuration manager 360 receives the configuration acquisition request 372 from the terminal 350 (Step 3901). In the configuration manager 360, the configuration acquisition request generation module 371 converts the configuration acquisition request 372 into the configuration acquisition command 374 of the monitored resources 400, and instructs the monitored resources 400 to acquire the component (Step 3902).

Upon reception of the acquired configuration information 375 from the monitored resources 400, the configuration manager 360 accepts the acquired configuration information 375 in the configuration acquisition request generation module 371, sends it to the configuration change request generation module 364, and stores it in the configuration information DB 365 (Step 3903). The configuration acquisition request generation module 371 extracts the component of the monitored resources 400 by analyzing the acquired configuration information 375 that was received (Step 3904). Incidentally, the extracted component shall be described by the XML and a name of the component shall be configured. The name of this component may be given by the monitored resources 400 side, or may be given by the configuration acquisition request generation module 371 when analyzing the component.

The configuration manager 360 performs processings of Step 3905 to Step 3908 on all the components extracted at Step 3904, stores the parent node in the temporary configuration XML 385, and configures the xpathID indicating the cross-reference 490 in the parent node.

First, at Step 3906, the tree transformation configuration 381 selects one of the extracted components, searches the baseline configuration table 383, and acquires the platform tree component XML 391 or the service provision tree component XML 392 with which the element name 390 agrees. This search is such that if the name of the component contained in the XML of the selected component agrees with the element name of the baseline configuration table 383, the platform tree component XML 391 or the service provision tree component XML 392 will be acquired.

Next, at Step 3907, if there is the acquired platform tree component XML 391 or the service provision tree component XML 392, the tree transformation configuration 381 stores it in the temporary configuration XML 385. When doing this, if there is a relationship of the cross-reference 490 between the platform tree component XML 391 and the service provision tree component XML 392, <xpathID> is contained like a description of XML of the “hypervisor” of FIG. 36.

Then, at Step 3908, the tree transformation configuration 381 determines whether the description of <xpathID> exists in the platform tree component XML 391 or the service provision tree component XML 392 stored in the temporary configuration XML 385, and if the description of <xpathID> exists and if a value of “value” is null, a value of the xpathID unique within the configuration information 500 (or within the monitored resources 400) is set to “value” and registers it in the xpath generation table 384.

Here, in the xpath generation table 384, as shown in FIG. 37, a single entry is comprised of xpathID 395, platform tree xpath 396, and service provision tree xpath 397.

By performing the above-mentioned processing on all the components, the tree transformation configuration 381 of the configuration manager 360 stores the parent node of the platform tree component XML 391 and the parent node of the service provision tree 610 in the temporary configuration XML 385, and if there is an xpathID indicating the cross-reference 490, gives a unique identifier to them.

Next, the configuration manager 360 performs the flowchart of FIG. 39, and configures the tree structure placed under the parent node that is stored in the temporary configuration XML obtained by the processing of FIG. 38. At Step 4001, the configuration acquisition request generation module 371 extracts all the components XML 391, 392 stored in the temporary configuration XML 385. The component XML such that the content of the parent node (parent) is blank (null) is stored in the temporary configuration XML 385. The extracted components XML are components XML 391, 392 of the parent node. Below, they are designated as the component XML of the parent node.

Next, the tree transformation configuration 381 of the configuration manager 360 performs processings at Steps 4002, 4003 on all the child nodes except child nodes such that the parent is blank among all the components extracted at Step 3904 of FIG. 38.

At Step 4003, the tree transformation configuration 381 acquires one component XML of the child node other than one such that the parent is blank. Then, it decides under which component of the parent node extracted at Step 4001 the acquired component XML of the child node is placed subordinately. This decision is done as follows: if the element name of the parent of the component XML of the child node agrees with the element name of the component XML of the parent node, the parent node shall be designated as the parent of the child node being focused currently.

Then, the tree transformation configuration 381 incorporates the component XML of the child node to be placed under the component XML of the above-mentioned decided parent node among the temporary configuration XMLs 385.

By performing the above-mentioned processing on all the child nodes, the child node is incorporated to be placed under the parent node within the temporary configuration XML 385 for the component extracted at Step 3904, and the platform tree component XML 391 and the service provision tree 610 are built up.

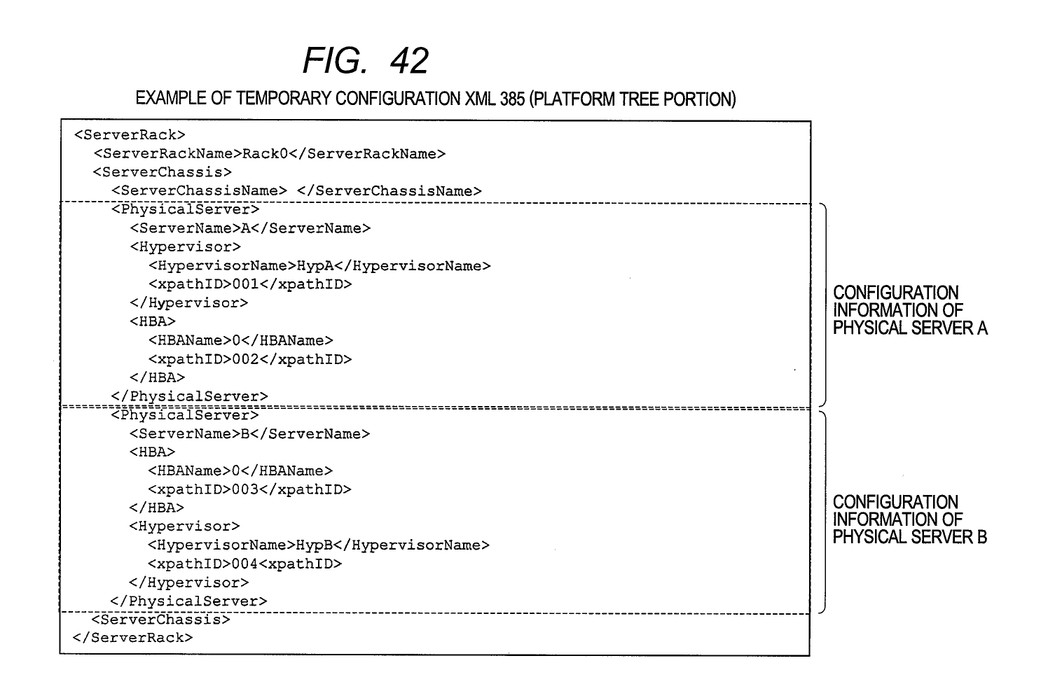

FIG. 42 shows an example of the temporary configuration XML 385. In it, elements of the baseline configuration table 383 are hierarchically arranged, and names (names defined by <ServerRackName>, <ServerChassisName>, <ServerName>, <HypervisorName>, and <HBAName> of FIG. 42) that are peculiar to the respective elements and xpathIDs are configured.

Next, the tree transformation configuration 381 performs the flowchart of FIG. 40 to update the xpath generation table 384. In the processings of FIG. 38 and FIG. 39, although the xpath between the parent nodes of the temporary configuration XML 385 is configured, xpath between the child node of the platform tree 600 and the parent node of the service provision tree 610 is not configured. Consequently, in the flowchart of FIG. 40, the xpath between the child node of the platform tree 600 and the parent node of the service provision tree 610 is configured.

The tree transformation configuration 381 performs the processings at Steps 4101-4103 of FIG. 40 on all the components of the xpath generation table 384.

The temporary configuration XML 384 is retrieved at Step 4101, and all the parent nodes are found. Step 4102 and Step 4103 are performed for all the parent nodes.

At Step 4102, the tree transformation configuration 381 retrieves the temporary configuration XML 385 and detects <xpathID>. The retrieval may be done giving priority either to depth or width.

At Step 4103, a path that the temporary configuration XML 385 traces until the tree transformation configuration 381 detect at the above-mentioned Step 4102 is designated as xpath, and the path xpath is registered in the platform tree xpath 396 or the service provision tree xpath 397 of the xpath generation table 384. Incidentally, regarding the determination of the platform tree and the service provision tree, the tree transformation configuration 381 can determine it by acquiring either identifier of <platform> or <service> stored in the baseline configuration table 383 of FIG. 36 for the component XML that detected the xpathID. Incidentally, xpathID 395 of the xpath generation table 384 just has to inherit the xpathID detected at Step 4102.

Next, the tree transformation configuration 381 performs the flowchart of FIG. 41 to generate the configuration information 500 by incorporating the xpath registered in the xpath generation table 384 into the temporary configuration XML 385.

The tree transformation configuration 381 performs the processings at Steps 4201-4203 on all the components of the xpath generation table 384.

At Step 4202, the tree transformation configuration 381 selects one entry in the xpath generation table 384. Then, the xpath of the platform tree xpath 396 of the entry of the selected xpath generation table 384 is replaced with a portion where the xpathID of the service provision tree is configured in the temporary configuration XML 385. Thereby, a description (XML) of the platform tree xpath 396 is incorporated in the pertinent xpathID of the service provision tree of the temporary configuration XML 385.

Next, at Step 4203, the tree transformation configuration 381 replaces the xpath of the service provision tree xpath 397 of an entry of the xpath generation table 384 currently selected with a portion where the xpathID of the platform tree is configured in the temporary configuration XML 385. Thereby, a description (XML) of the service provision tree xpath 397 is incorporated in the xpathID of the platform tree of the temporary configuration XML 385.

After terminating the processings of the above-mentioned Steps 4202, 4203 for all entries of the xpath generation table 384, the flow proceeds to Step 4204. At Step 4204, the tree transformation configuration 381 stores the contents of the temporary configuration XML 385 in the configuration information database 365 as the configuration information XML 500.

The above processings generate the configuration information XML 500a of the platform tree 600 shown in FIG. 32A and FIG. 32B and the service provision tree 610 shown within FIG. 33. Incidentally, the configuration information XML 500a of FIG. 32A, FIG. 32B, and FIG. 33 is one to which the monitoring system 100 gives a unique component ID as described above.

### <Relation of Performance Statistics>

Next, relation of the performance statistics and the configuration information will be explained.

As the performance statistics of the virtual server 422, there is considered, for example, information such that the operation information, such as the CPU utilization and the memory utilization, that the OS 423 acquires is subjected to the statistical processing as described above. That is, it is possible to consider the utilization of the virtual CPU and the utilization amount of memory that the server virtualization module 421 provides to the virtual server, or the utilization (transfer amount) etc. of the virtual I/O device (I/O devices that virtualizes HBA, NIC, etc.) as operation information indicating the performance of the virtual server 422 and to use this information as the performance statistics after conducting a predetermined statistical processing.

On the other hand, as the performance statistics of the physical server 411, it is considerable that the CPU utilization of the server virtualization module 421 itself, the utilization amount of the memory 413, the utilization rate (transfer quantity) of the I/O devices (HBA and NIC), etc. are treated as operation information indicating the performance of the virtualization module 421, and are processed to be the performance statistics by performing a predetermined statistical processing.

Then, in this embodiment, the monitoring system 100 allocates a unique component ID (ID in the figure) to each node of the configuration information XML 500a, and by associating statistics ID being configured in each performance statistics with this component ID, trace of a history of the configuration before and after the change of the configuration information and the performance statistics is made easy. Incidentally, as a node in the configuration information, the component ID given to the physical server 411 or the virtual server 422 can be treated as a node. Similarly, the statistics ID may be treated as a node.

Moreover, it is not necessarily required to discriminate the component ID and the statistics ID, and there is also a method of managing these IDs by giving values that do not overlap mutually. In the following example, although the component ID and the statistics ID are shown in the same field in order to abridge the number of fields, there is also a method for managing them by adding a field to discriminate them. Either case does not produce an essential difference to the other case in applying the present invention.

FIG. 9 is a diagram that excerpts a part of the tree representation of the configuration information XML 500b after moving the virtual server α from the configuration information XML 500a shown in FIG. 7 to a physical server B. This configuration information XML 500b is an example where the configuration information 134 of the revision 131=2 shown in FIG. 4 is represented by a tree. It is assured that the component ID and the statistics ID related to the virtual server α having moved are the same between before and after the movement of the revision 131=1 to 2. Thereby, it becomes possible to continuously trace the performance statistics about the operation before and after the movement by the configuration change.

That is, as shown in FIG. 7, when the virtual server of the component ID=9 assigned to the physical server A of the component ID=3 is moved to the physical server B, the component ID=3 of the virtual server α related with the physical server A and an identifier (statistics ID) of a virtual resource placed under the control of the virtual server are deleted as shown in FIG. 9, and the same component ID and the same statistics IDs as the component ID=9 of the virtual server α that is moved and the identifier (statistics ID) of a virtual resource placed under the virtual server α are assigned to the physical server B of the component ID=4 that is a movement destination.

### <Assigned ID Management Table>

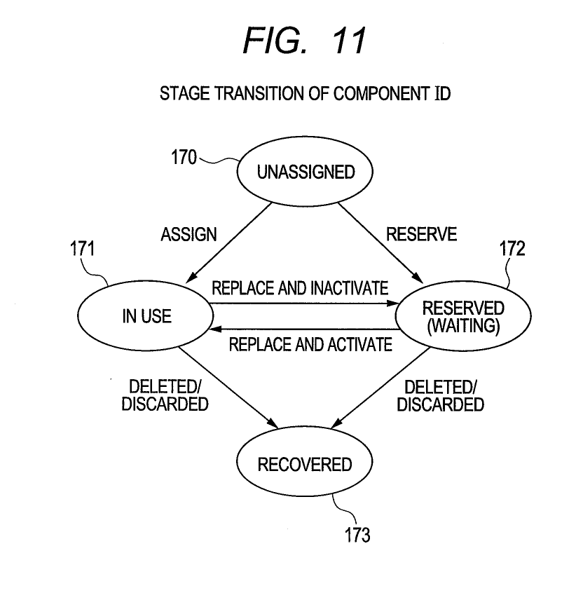

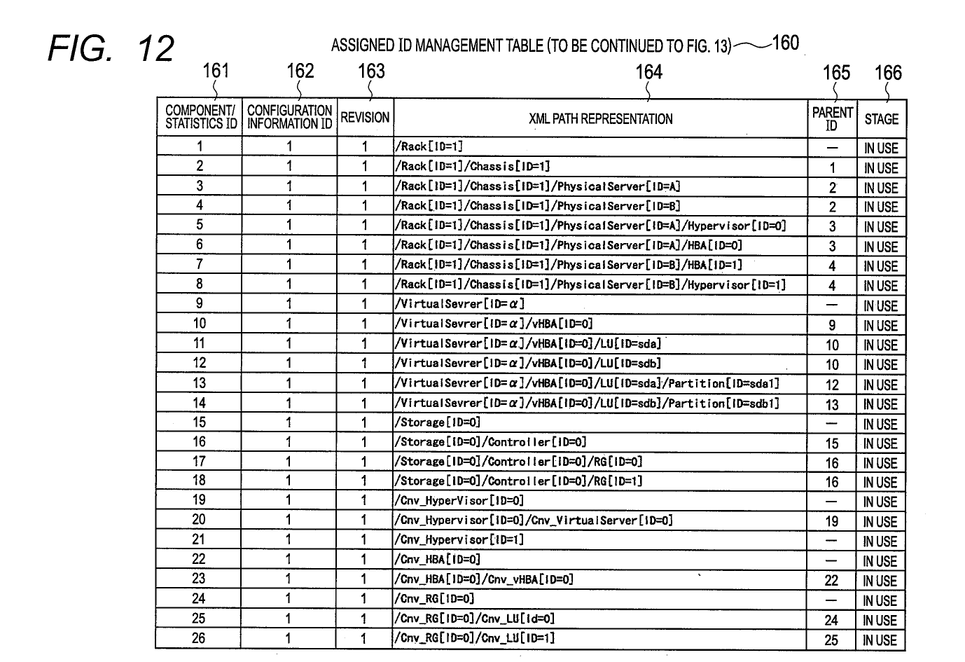

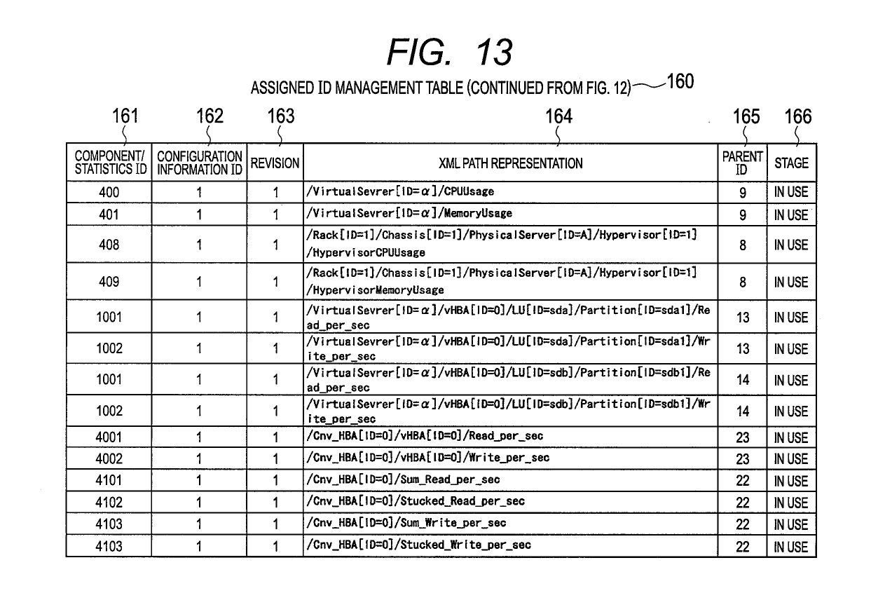

FIG. 11 is a stage transition diagram of the component ID that the configuration information relation management module 230 manages. The component ID is an identifier that the configuration information relation management module 230 assigned to the component of the base resources 410 or the virtual resources 420 and that is unique within the monitoring system 100. These component ID and statistics ID are stored in the component/statistics ID 161 in the assigned ID management table 160 (FIG. 12, FIG. 13) that the configuration information relation management module 230 manages.

When the configuration information relation management module 230 allocates the component ID to the component of the base resources 410 and the virtual resource 420, the component ID is registered in the assigned ID management table 160 in order to manage a stage of component ID.

Upon being assigned, the component ID transits from a stage of being unassigned 170 where assignment has not been done (including ID that is not registered in the table) to a stage of being used 171. Moreover, when the ID is reserved for a component in standby or for other reason, the stage transits to being already reserved or being in standby 172. Regarding the being in use 171 and the being in standby 172, if there is alternation due to a failure, movement, etc., the component ID may transit between two stages. When deletion or abandonment of the component is done, the ID transits to a stage of being already collected 173 so that it may not be reused for another purpose. As a method for generating a new ID value, for example, a method where a monotonously increasing natural number is used is considerable.

FIG. 12 and FIG. 13 is a composition example of the assigned ID management table 160 whose IDs are given to the components of the configuration information XML 500a of FIG. 7. Each record includes fields of component ID or statistics ID 161, configuration information ID 162, revision 163, XML path representation 164, parent component ID (parent ID in the FIG. 165, stage 166 of a component ID. The monitoring system 100 gives these values.

Here, the XML path representation 164 includes information required to specify each node in an XML tree. Although in the example of FIG. 12 and FIG. 13, the method of specifying the ID of the server rack 510, the ID of the server chassis 520, the ID of the physical server 411, and the ID of the virtual server 422 sequentially was showed, in addition to the above, there are considerable a method of specifying the physical server 411 and the virtual server 422 by server names that the user gave, and a method of specifying a UUID of the guest OS that operates, etc. With any method, as long as the node (each component) can be specified uniquely, it does not make a difference in applying the present invention.

Moreover, the component whose parent component ID (parent ID in the FIG. 165 is “-,” it indicates that it acts as the parent node in the platform tree 600.

### <XML Representation of Configuration Information XML>

FIG. 32A, FIG. 32B, and FIG. 33 show an expression of a hierarchical structure of the configuration information XML 500a by XML before the virtual server α of the physical server=“A” shown in FIG. 7 is moved to the physical server “B.”

In FIG. 32A and FIG. 32B, a tree structure is constructed hierarchically with Server Rack node showing the server rack 510, ServerChassis node showing the server chassis 520, PhysicalServer node showing the physical server 530, Hypervisor node showing the server virtualization module 421, and HBA node showing the HBA 415.

Moreover, the VirtualServer node indicating a virtual server 540, the vHBA node representing the vHBA 460, the LU node representing the LU 465, and the Partition node representing the partition 470 constitute a tree structure hierarchically similarly with the platform tree 600 shown in FIG. 7.

Each node has component_id representing the component ID as an attribute of the each node. Moreover, under the VirtualServer node, there are respective nodes of ServerName indicating a server name, CPUUsage indicating the CPU utilization, and MemoryUsage indicating the memory utilization, and each of CPUUsage and MemoryUsage nodes has a statistics ID attribute showing the statistics ID. Incidentally, in the case of managing the component ID and the statistics ID without distinguishing them in particular, implementation where any node is given the component_id attribute instead of the statistic id attribute is considerable. No essential difference is produced between the both cases.

On the other hand, in FIG. 33, a hierarchical structure of the service provision tree 610 shown in FIG. 7 is described by the XML in a similar manner of the above-mentioned platform tree 600. The configuration information 500a of FIG. 33 is such that attributes of the parent-child relationship (parent and child) defined by each component 390 that is defined by the baseline configuration table 381 shown in FIG. 36 are described by a single XML on a hierarchical structure on the tree.

Then, in FIG. 32A and FIG. 32B, the above-mentioned xpath is configured as the cross-reference 490 between each node of the platform tree 600 shown in FIG. 7 and each node of the service provision tree 610 of FIG. 33.

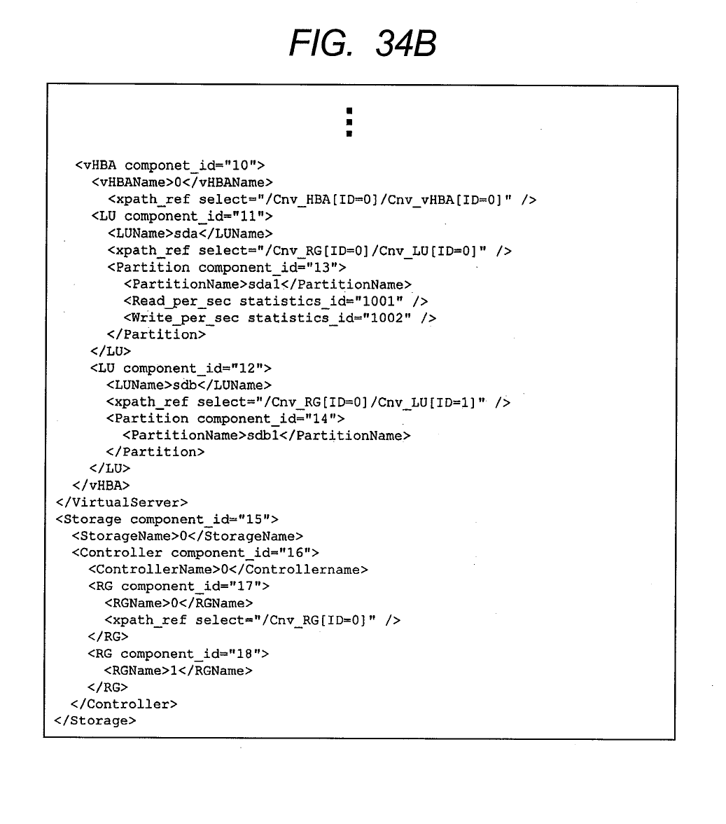

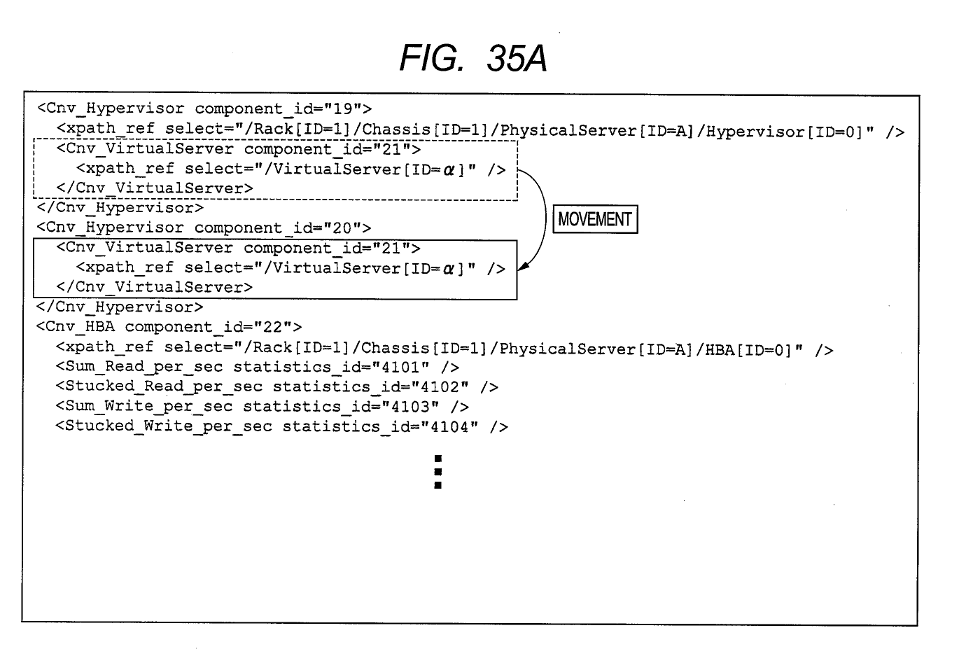

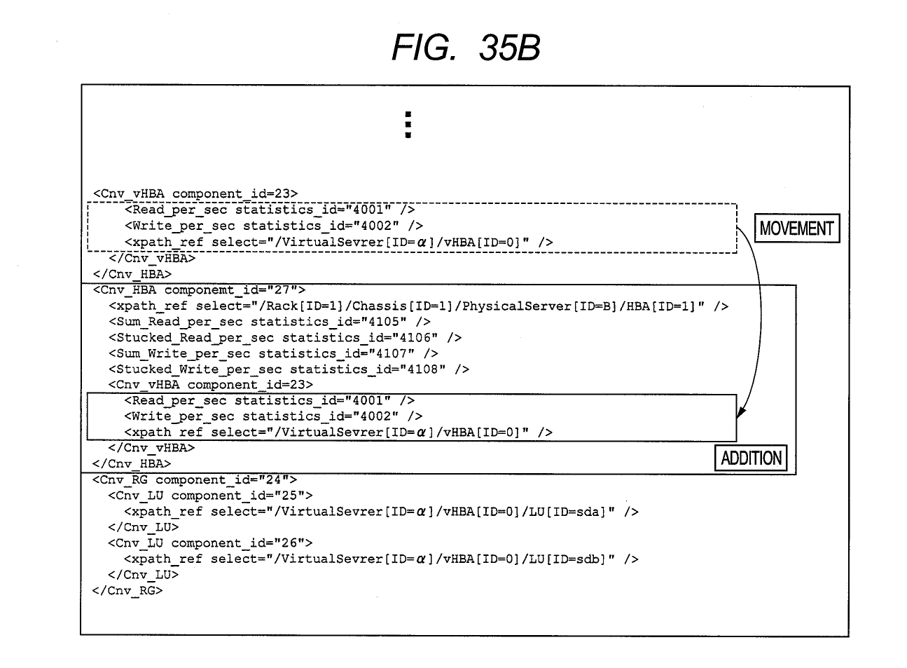

FIG. 34A, FIG. 34B, FIG. 35A, and FIG. 35B are diagrams showing change procedures as with the XML representation in the case of generating the configuration information XML 500a and the configuration information XML 500b when moving the virtual server α of the physical server=“A” to the physical server “B.”

In FIG. 34A-FIG. 35B, the node placed under the virtual server α in the configuration information XML 500a is moved to be placed under the physical server B from being placed under the physical server A in the configuration information XML 500b. In this processing, the component ID and the statistics ID placed under it including the virtual server α inherit the same IDs, which enables tracing of the performance statistics of operation and the change history before and after the movement. Moreover, description of the platform tree including the virtual server α that is moved requires only change of xpath, and the movement of the server can be dealt with only by newly adding a virtual server in the service provision tree 610.

### <Operation Performance Statistics Display>

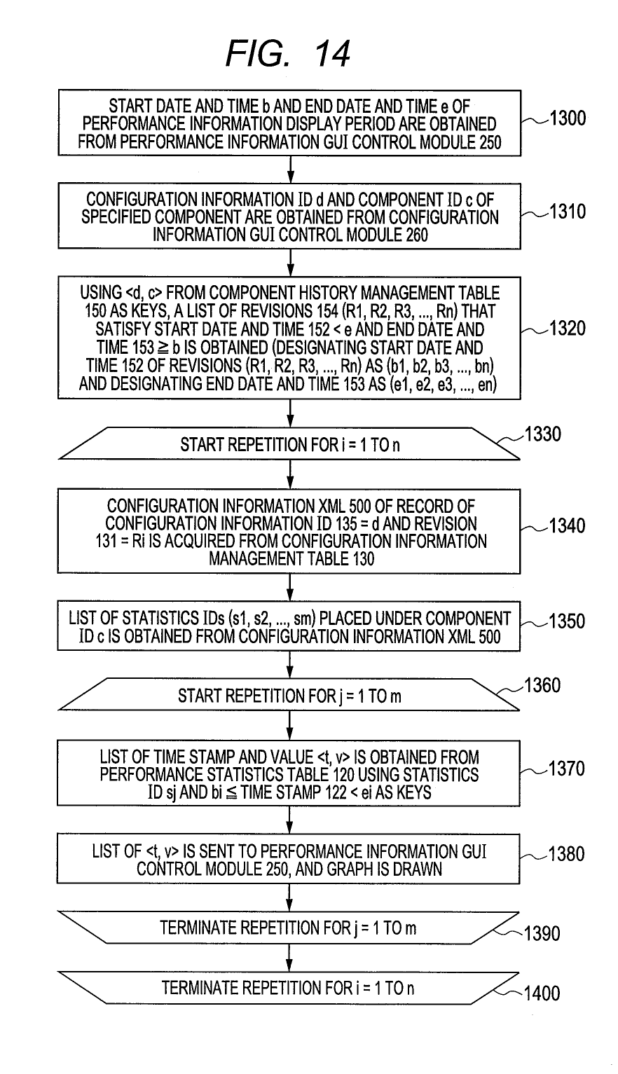

FIG. 14 shows a flowchart of a processing performed in the performance information management module 190 of the monitoring system 100 when displaying the performance statistics about the operation in the terminal 350. This processing is performed when the performance information GUI control module 250 accepts a request of performance statistics from the terminal 350. This request stores the start date and time of a display period of the performance statistics in variable b, does the end date and time in variable e, does the configuration information ID of the component in variable d, and does the component ID in a variable c.

First, at Step 1300, the performance information management module 190 obtains the start date and time b and the end date and time e of the performance statistics display period from the performance information GUI control module 250. The flow proceeds to Step 1310.

At Step 1310, the performance information management module 200 obtains the configuration information ID 135=d and the component ID=c of the specified component from the configuration information GUI control module 260. The flow proceeds to Step 1320.

At Step 1320, the history information management module 210 obtains a list of the revisions 154 (R1, R2, . . . , Rn) each of which satisfies the start date and time 152<e and the end date and time 153>=b based on variables b, e, d, and c obtained from the performance information management module 190 and the configuration information management module 200, using <d, c> from the component history management table 150 as keys. Here, the start date and time 152 of each revision is designated as (b1, b2, . . . , bn), and the end date and time 153 is designated as (e1, e2, . . . , en). In the case of the newest revision, ei (however, i=1 to n) may be null. The flow proceeds to Step 1330.

Next, for each revision Ri (however, i=1 to n) that is obtained, Steps 1340-1390 are repeated.

At Step 1340, a record with the configuration information ID 135=d and the revision 131=Ri is selected from the configuration information management table 130, and the configuration information XML 500 (500a-500c) is acquired from the configuration information 134 in the configuration information management table 130. The flow proceeds to Step 1350. Note that a generic term of the configuration information XML 500a-500c shall be the configuration information XML in the following explanation.

At Step 1350, for the acquired configuration information XML 500, the component ID obtains a list of statistics IDs (s1, s2, . . . , sm) placed under the variable c. However, the list of statistics IDs is expressed by sj with j=1 to m. The flow proceeds to Step 1360.

Next, the Steps 1370-1380 are repeated for each obtained sj.

At Step 1370, a list of sets <t, v> of the time stamp 122 of a record that satisfies bi<=time stamp 122<ei and the statistics 123 are obtained using the statistics ID 121=sj from the performance statistics table 120 as a key. The flow proceeds to Step 1380.

At Step 1380, the list of <t, v> is sent to the operation information GUI control module 250, and a graph is outputted on the display device of the terminal 350 by this list <t, v> and the component ID.

The above is a flowchart of the processing performed in the performance information management module 190 at the time of displaying the performance statistics about operation.

By the above-mentioned processing, it becomes possible for the performance information management module 190 to make the performance statistics displayed continuously crossing over a time point of the configuration change even when the configuration change, such as migration, takes place for the statistics ID 121 being made related with the same component ID.

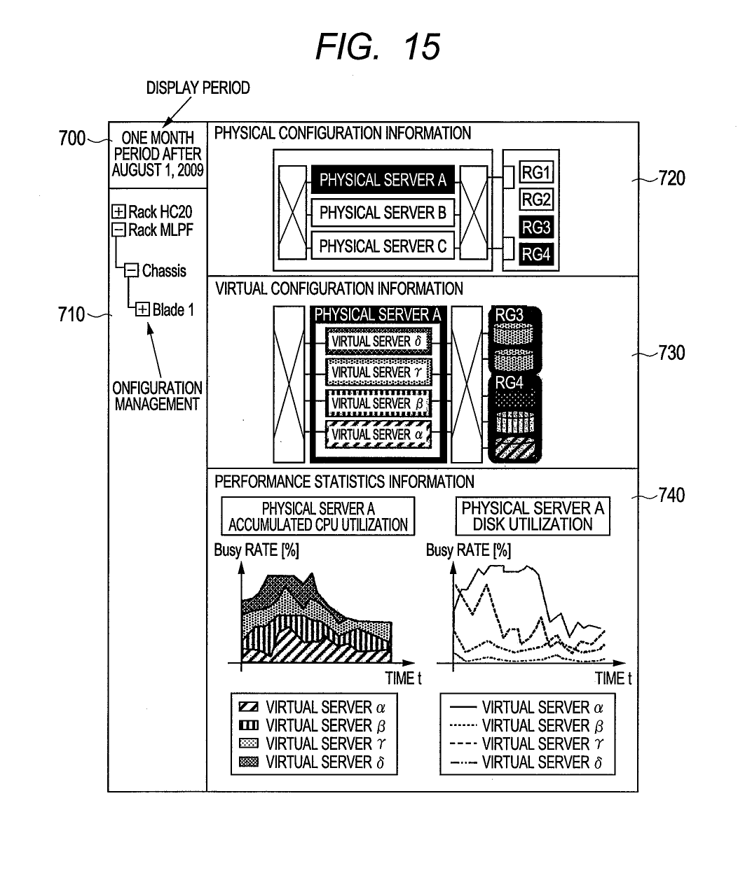

FIG. 15 is an example of an operation statistics monitor screen displayed on a terminal 350 of the monitoring system 100 to which the present invention is applied.

The operation statistics monitor screen is equipped with a portion 700 for displaying a display period on the left-hand side in the figure, and a portion 710 for performing configuration management according to the platform tree 600 such as a rack and a chassis. Moreover, an area for displaying the performance statistics about the components and their operations is set on the right-hand side in the figure. The area is comprised of a physical configuration information display area 720 for displaying the physical configuration information (the components of the base resources 410), a virtual configuration information area 730 for displaying the virtual configuration information (the components of the virtual resources 420), and an operation performance statistics display area 740 for displaying the performance statistics.

The physical configuration information display area 720, the virtual configuration information display area 730, and the operation performance statistics display area 740 are linked with one another, and details of the virtual configuration information (the components of the virtual resources) about the component (here, the physical server A) specified in the physical configuration information area 720 are displayed in the virtual configuration information display area 730. Moreover, in this case, operation performance statistics corresponding to the physical server A is displayed in the area 740.

Here, when the virtual server α in the virtual configuration information display area 730 is specified by the input device (e.g. a pointing device, such as a mouse) of the terminal 350, only the performance statistics related to the virtual server α is extracted and is displayed in the operation performance statistics display area 740. In the example of illustration, the CPU utilization of the virtual server α is displayed in a time-series graph on a left-hand side area in the operation performance statistics display area 740, and an I/O device utilization (a utilization of read and write etc.) of the virtual server α is displayed on a left-hand side area therein.

Incidentally, when any one of the physical servers A-C in the physical configuration information display area 720 is specified with the input device of the terminal 350, the performance statistics relevant to the selected physical server is extracted and is displayed in the operation performance statistics display area 740. Moreover, although FIG. 15 showed the example in which the server virtualization module 421 is omitted in the physical configuration information display area 720, if the server virtualization module is operating hierarchically on the physical server, the physical server and the server virtualization module can be displayed.

Thus, a point that a kind of graph displayed in the operation performance statistics display area 740 changes according to whether the focused component is the physical component or the virtual component is one of features of this monitoring system 100.

On the above-mentioned operation statistics monitor screen of FIG. 15, one piece of screen information is generated by the performance information GUI control module 250, the configuration information GUI control module 260, and the history information GUI control module 270 of the monitoring system 100, and the monitoring system 100 outputs the screen information to the terminal 350. Then, the terminal 350 draws the received screen information on the display device.

### <Operation of Performance Statistics Collector>

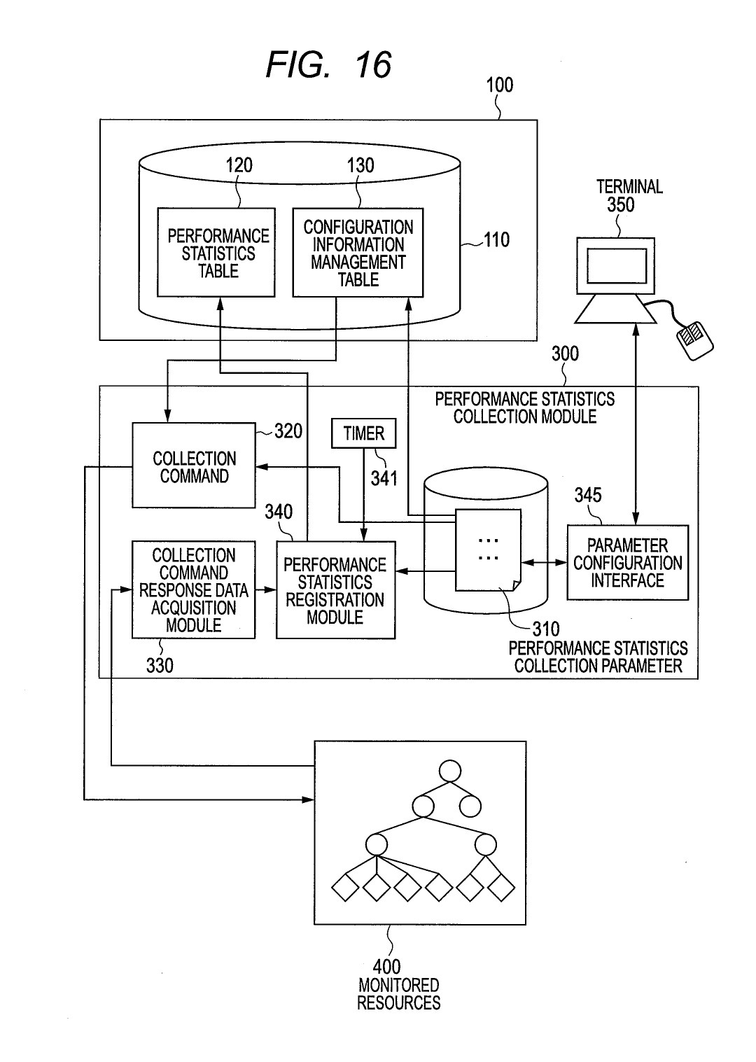

Details of a processing performed in the performance statistics collector 300 will be described using FIG. 16 to FIG. 19 below.

FIG. 16 is a block diagram showing a configuration of the performance statistics collector 300. The performance statistics collector 300 holds the performance statistics collection parameter 310 and the contents of the performance statistics collection parameter 310 are configured from the input device etc. of the terminal 350 through a parameter configuration interface 345.

In the normal operation of the monitored resources 400, the contents of the performance statistics collection parameter 310 are not altered unless large change is added to the monitored resources 400 in particular after an item to be collected first is decided and configured. The performance statistics collector 300 further includes a collection command execution module 320 for executing a collection command according to an operation performance statistics collection parameter 310, a collection command response data acquisition module 330 that receives the operation information being an execution result of the collection command and performs a predetermined processing, a performance statistics registration module 340 that generates a statistic from a result that agrees with a condition being set in advance in the operation information further collected and stores it in the performance statistics table 120, and a timer 341.

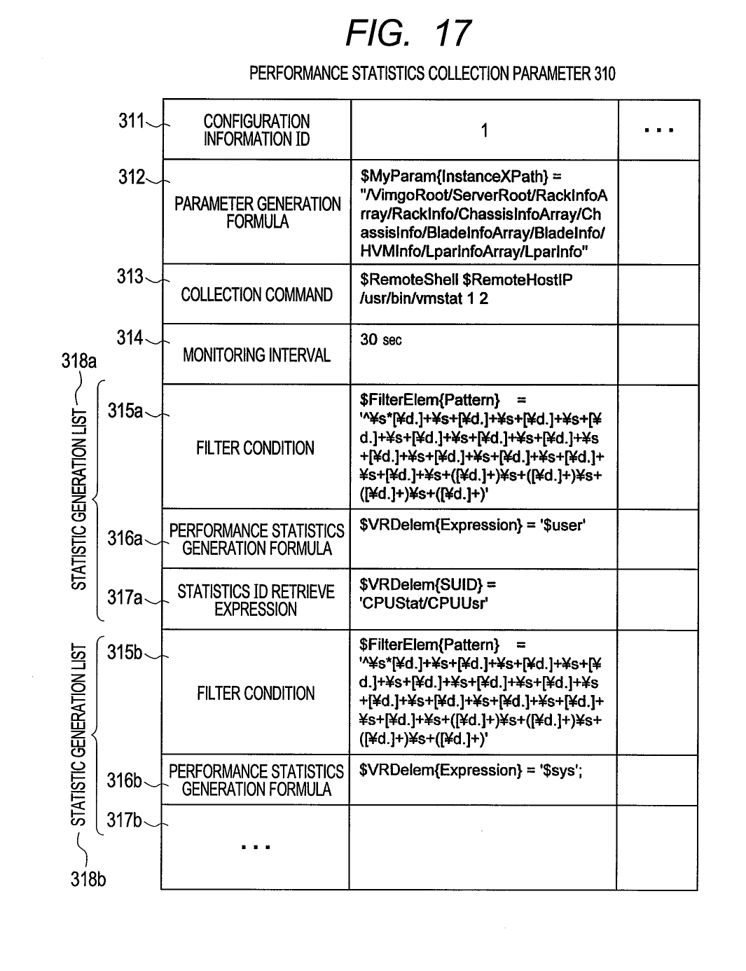

FIG. 17 is a definition of the performance statistics collection parameter 310 that the performance statistics collector 300 uses. FIG. 17 is a line (or record) of one parameter of the performance statistics collection parameters 310, and is comprised of one or more performance statistics generation lists 318a, 318b made up of configuration information ID 311, parameter generation formula 312, collection command 313, monitor interval 314, filter condition 315a, 315b, performance statistics generation formula 316a, 316b, and statistics ID retrieve expression 317a, 317b. Note that, in the below, a generic term of the filter conditions 315a, 315b is designated as a filter condition 315, a generic term of the performance statistics generation formulas 316a, 316b is done as a performance statistics generation formula 316, a generic term of the statistics ID retrieve expressions 317a, 317b is done as a statistics ID retrieve expression 317, and a generic term of the performance statistics generation lists 318a, 318b is done as a performance statistics generation list 318.

Contents of the performance statistics collection parameter 310 are configured from the input device etc. of the terminal 350 that the administrator etc. operates as described above. In the configuration information ID 311, a value that corresponds to the configuration information ID 135 of the configuration information management table 130 of FIG. 4 is stored. In the collection command 313, the collection command of the operation information that is made to be executed on the target configuration information ID 311 is stored. In Monitor Interval 314, a collection period of the operation information that is configured in the terminal 350 is stored.

The terminal 350 requires generation of the statistic to the parameter configuration interface, specifies the configuration information ID 135 of the configuration information management table 130, and sets the above-mentioned parameters. The parameters being configured are stored in the performance statistics collection parameter 310 as a new record. The performance statistics collector 300 notifies the configuration information ID and the statistics ID to the monitoring system 100, and the statistics ID is stored in the configuration information 500 in the configuration information management table 130.

In the parameter generation formula 312, a formula for specifying a server name, an IP address, etc. contained in the configuration information XML 500 is configured, as will be described later.

As one example of the collection command 313, there is configured a command that comply with the SNMP, a protocol for collecting the operation information, as will be described later.

As one example of the filter condition 315, a condition as shown by $FilterElem (shown in FIG. 17) is configured.

As one example of the performance statistics generation formula 316, a formula for calculating a percentage, an average, and a total value of the collected operation information is configured, as shown in FIG. 17.

As one example of the statistical value retrieve expression 317, a formula for calculating the statistics ID corresponding to an instance of the configuration information XML 500 is configured, as shown in FIG. 17.

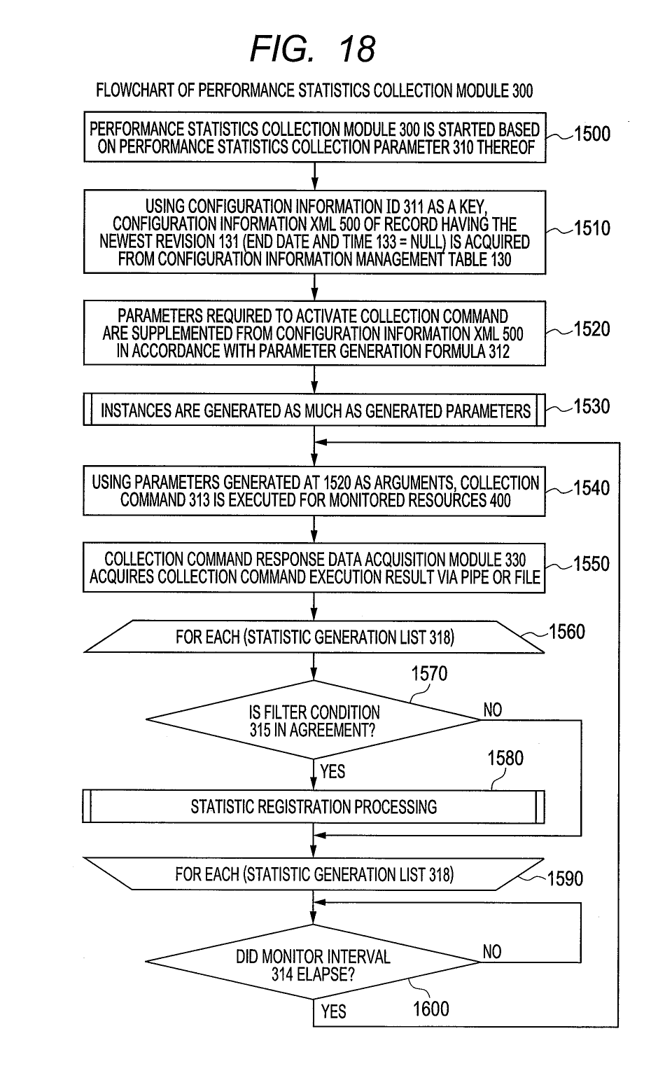

FIG. 18 shows a flowchart of a processing performed in the performance statistics collector 300.

The performance statistics collector 300 is started reading the performance statistics collection parameter 310 being configured in advance as shown in FIG. 17 as a parameter. Here, although in order to simplify the explanation, it is supposed that a different parameter is given to each row of the performance statistics collection parameter 310 to make start, a single program may be enabled to issue multiple collection commands.

At Step 1500, a program of the performance statistics collector 300 is activated and the flow proceeds to Step 1510.

At Step 1510, the performance statistics collector 300 refers to the performance statistics collection parameter 310 of FIG. 17 and acquires the configuration information XML 500 of a record having the newest revision 131 from the configuration information management table 130 using the configuration information ID 311 as a key, and the flow proceeds to Step 1520.

At Step 1520, the performance statistics collector 300 supplements a parameter required to activate the collection command 313 from the configuration information XML 500 according to the parameter generation formula 312 of the performance statistics collection parameter 310, and the flow proceeds to Step 1530.

Here, the parameter generation formula 312 is a formula for specifying parameters (a server name, an IP address, etc.) required to specify the instance contained in the configuration information XML 500, and as one example, a method for specifying it by an XML path format is considerable. For example, one example of the XML path format for extracting a server name of the virtual server from the XML representation shown in FIG. 32 becomes “/VirtualServer/ServerName.”

Generally since multiple nodes that match the parameter generation formula 312 exist in a single configuration information XML 500, the generated parameters come in a list of multiple parameters.

At Step 1530, the instances of the performance statistics collector 300 are generated according to the number of the parameters generated at Step 1520. The generation of the instance can also be realized by duplication. As methods for duplicating the instance, there are considerable, for example, a method for duplicating it using fork system call of Unix (registered trademark) and a method whereby a thread is divided. Incidentally, as long as a collection processing of the operation information can only be executed in parallel, it is not necessarily required to duplicate a process and a thread. The flow proceeds to Step 1540.

At Step 1540, the collection command execution module 320 executes the collection command 313 on the monitored resources 400 setting the above-mentioned generated parameter as an argument. As the collection command 313, there can be considered a command in accordance with SNMP that is a protocol for collecting the operation information, communication to an agent that has been installed in advance, a method for issuing a command (vmstat, iostat, etc. in Linux (registered trade mark)) for acquiring the operational condition using a remote shell etc., and the like. The flow proceeds to Step 1550.

At Step 1550, the collection command response data acquisition module 330 acquires a result of the collection command 313 that was executed at Step 1540 via a pipe (standard output) or file. The flow proceeds to Step 1560.

At Step 1560, for each set of the operation information generation list that is comprised of sets each including the filter condition 315, the performance statistics generation formula 316, and the statistics ID retrieve expression 317 given as parameters, Step 1570 to Step 1590 are carried out repeatedly.

At Step 1570, it is judged whether an obtained result agrees with the filter condition 315. When not being in agreement with the filter condition 315, since the result does not contain a statistic falling under the aggregation object, the flow proceeds to Step 1590. When being in agreement with the filter condition 315, after the performance statistics registration module 340 performs a registration processing of the statistic at Step 1580, the flow proceeds to Step 1590.

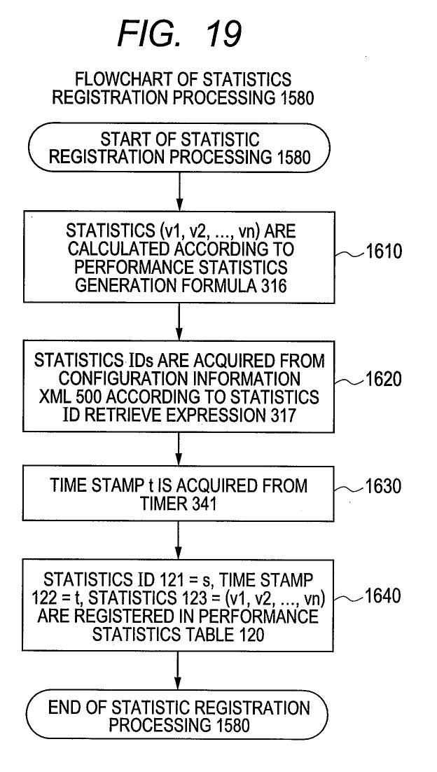

The registration processing of the statistic at Step 1580 will be explained in detail using FIG. 19 later.

At Step 1590, the flow returns to Step 1560 and Steps 1570 and 1580 are repeated for the rest of the sets in the performance statistics generation list 318 comprised of the sets each including the filter condition 315, the performance statistics generation formula 316, and the statistics ID retrieve expression 317. When all the sets have been processed, the flow proceeds to Step 1600.

At Step 1600, the timer 341 is checked to know whether the monitor interval 314 has elapsed, and if not, the flow waits until the time elapses. The follow returns to Step 1540 after the lapse.

The above is a flowchart showing operations of the performance statistics collector 300.

Next, FIG. 19 shows a detailed flowchart of a statistic registration processing 1580 performed in the performance statistics registration module 340.

At Step 1610, the performance statistics registration module 340 calculates statistics according to the performance statistics generation formula 316 of the performance statistics collection parameter 310. Here, the statistics are statistics that correspond to the statistics 123 registered in the performance statistics table 120, and are comprised of an average, a minimum, a maximum, a standard deviation, or the number of samples of the collected operation information, etc. In the case where the statistics are calculated from only one value, the average=the minimum=the maximum stands and the standard deviation and the number of samples shall be zero and moduley, respectively. The performance statistics generation formula 316 of the performance statistics collection parameter 310 is a formula for generating a statistic from an output result of the collection command 313 acquired at Step 1550. The performance statistics generation formula 316 may be considered to include a processing of, in the case of a figure of percents, dividing the operation information by 100 and a processing of finding an average and a sum total of two values. The flow proceeds to Step 1620.

At Step 1620, the statistics ID is acquired from the configuration information XML 500 according to the statistics ID retrieve expression 317, and is stored in the variable s. Here, the statistics ID retrieve expression 317 is a formula to find a corresponding statistics ID (it is often the case that it is placed under an instance node on the configuration information XML node) from an instance of the configuration information XML 500, and using the XML path format is conceivable, as one example. For example, in the case of the configuration information XML 500a of FIG. 32 and FIG. 33, the expression indicating an instance of the hypervisor is “/ServerRack/ServerChassis/PhysicalServer/Hypervisor,” and an XML path expression indicating the statistics ID of the CPU utilization of the virtual server becomes

“./CPUUsage@statistics_id.”
The flow proceeds to Step 1630.

At Step 1630, the time stamp t is acquired from the timer 341, and the flow proceeds to Step 1640.

At Step 1640, statistics ID 121=s, the time stamp 122=t, and the statistics 123=(v1, v2, . . . , vn) are registered in the performance statistics table 120.

The registration processing 1580 of the statistic is completed by the above procedures.

### <Automatic Performance Statistics Analysis of Components of Base Resources>

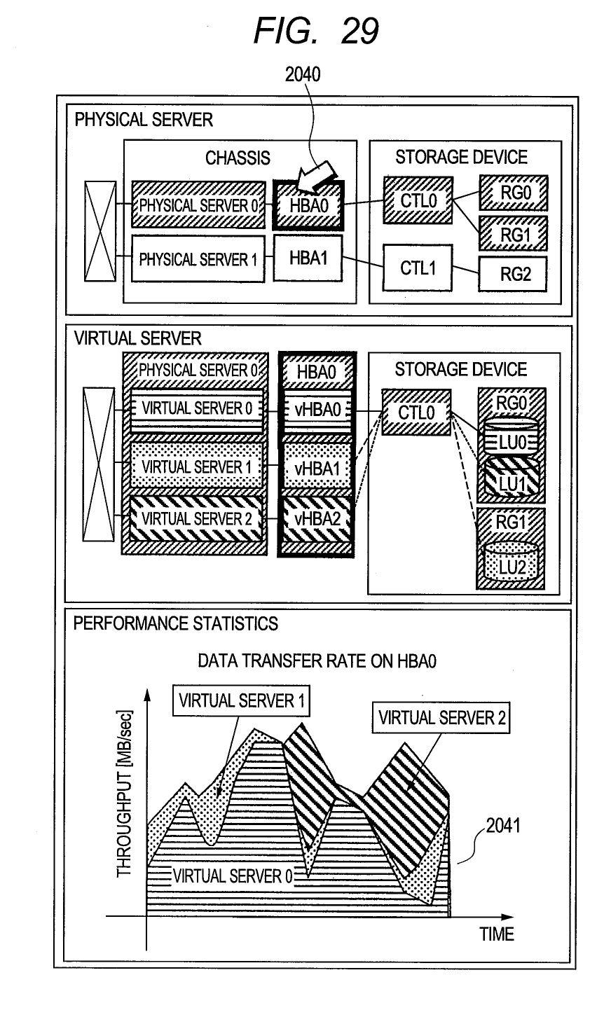

An outline of an automatic performance statistics analysis performed on the components of the base resources 410 currently shared among the virtual resources 420 of the monitored resources 400 will be explained using FIG. 29.

FIG. 29 is an example showing a relation between the configuration information and the performance statistics displayed in the terminal 350 of the monitoring system 100 of FIG. 1 on one screen.

Here, a scenario in which the user of the monitoring system 100 investigates an operating situation of the HBA 415 that the virtual servers 422 share and investigates which virtual server uses most the HBA 415 is assumed.

First, the user of the monitoring system 100 clicks the system component that is intended to be monitored with the I/O device such as a mouse in the terminal 350. The HBA0 makes clicking in FIG. 29 (2040). Then, after the monitoring system 100 performs the below-mentioned performance statistics analysis processing, it displays the data transfer rates (throughputs) on the HBA0, changing a color (or pattern) for each virtual server in a form of a stacked bar chart (2041). In order to make such a stacked bar chart of the performance statistics for each virtual server, in the case where relevant data has been successfully measured directly, for example, in the case of the CPU utilization of the processor 412 that the server virtualization module 421 allocates to each virtual server 422, what is necessary is just to display the measured numerical values in the stacked bar chart as they are. However, as shown in FIG. 29, in the case of the HBA 415, if special hardware is not installed for the HBA 415, the data cannot be measured in obtaining the performance statistics for each virtual server 422. Then, the throughput of the disk access going through the HBA0 is regarded as a data throughput of the HBA0, and the stacked bar chart of the throughput values of the respective servers 422 is created, whereby the throughput of the HBA0 can be analyzed. The present invention has an object to automate such an analysis processing.

### <Data Structure>

The data structure of the performance statistics will be explained using FIG. 25. Principally, it is one that combines the platform tree 600 and the service provision tree 610 that were explained using FIG. 7, FIG. 32, and FIG. 33, by cross-reference. In the platform tree 600, the HBA 415 exists under the physical server 411. The performance statistics 582 related with the HBA 415 has become a null set. On the other hand, the vHBA 460 exists under the virtual server 422, the LU 465 exists thereunder, and the partition 470 exists further thereunder. Performance statistics 581 being made related with the vHBA 460 is a null set. Furthermore, there is the statistic (the performance statistics of a disk) 580 that is made related with the partition 470.

Data of the performance statistics belonging to the service provision tree 610 will be explained. In the service provision tree 610, the HBA 4150 is made to be the parent node and the vHBA 4650 exists thereunder. The HBA 4150 is made related with performance statistics 4580. Then, the relationship of the cross-reference is established between the HBA 415 and the HBA 4150 and between the vHBA 460 and the vHBA 4650 (dashed lines of FIG. 25).

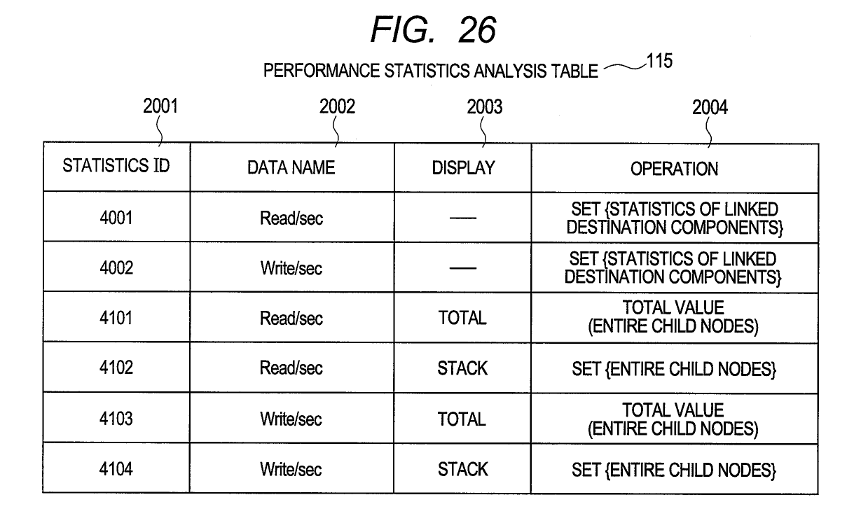

The performance statistics 4580 (statistics IDs=4001-4002), 4582 (statistics IDs=4101-4104) on the service provision tree 610 are defined by the performance statistics analysis table 115 shown in FIG. 26. The performance statistics analysis table 115 of FIG. 26 is one of the components of the monitoring system 100 of FIG. 2. The configuration of the performance statistics analysis table 115 is such that a single record is comprised of statistics ID 2001, data name 2002, display 2003, and operation 2004.

The display 2003 specifies a form of the graph displayed in the terminal 350. In the display 2003, “-” indicating that data corresponding to the child node is not an object to be displayed is configured. For the parent node, pieces of data aggregated by an operation content of the operation 2004 are displayed on the screen of the display device of the terminal 350 in the form of the display 2003. The “sum total” being set in the display 2003 is a numerical value obtained by adding all the numerical values of the child nodes, and “stacking” means a graph in which numerical values of the respective nodes are stacked so that occupancy ratios of the respective nodes can be understood.

For a column of the operation 2004, how to calculate the statistics is specified. An operation whose name is “set { }” returns a set specified by “{ }” as a set, as it is. In an operation whose name is “total value [ ],” a value obtained by adding all the numerical values of a set specified by “[ ]” becomes a return value. Although not shown in the figure, as an operation, other set operations, such as an average, a maximum, and a minimum, can be specified.

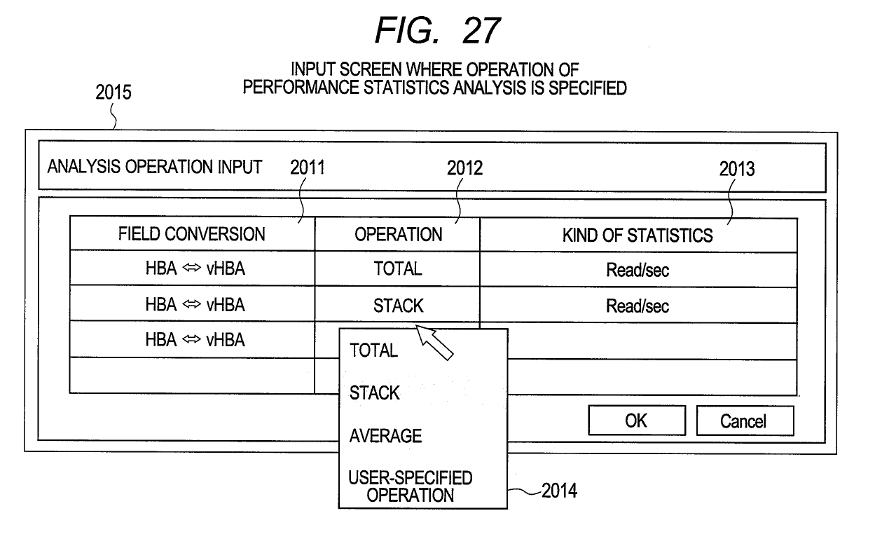

Setting of the performance statistics analysis table is specified by the administrator inputting from the input device of the terminal 350 on an input screen 2015 of FIG. 27 where an operation of operation time analysis is specified. The administrator calls this input screen 2015 from the menu screen displayed in the terminal 350 by requesting the configuration information GUI control module 260 from the terminal 350 of FIG. 2. Then, the configuration information management module 200 searches a list of the service provision trees 610 from the configuration information management table 130, and the configuration information GUI control module 280 displays the search result on the window screen (Screen 2015) of the terminal 350, opening it newly thereon.

At this time, kinds (a utilization, a throughput, etc.) of the performance statistics are also retrieved simultaneously. On the input screen 2015, a list of the components of the service provision tree 610 is displayed in a column of the field conversion 2011, and the user of the monitoring system 100 selects a desired operation form the pull-down menu 2014 displayed in the column of the operation 2012. Furthermore, the kind 2013 of the statistic is also selected with a pull-down menu (not illustrated). Incidentally, the kind 2013 of the statistic corresponds to the data name 2002 in the performance statistics analysis table 115 that the statistics ID 2001 indicates, and the modules (read/sec, write/sec, etc.) of the performance statistics are configured for it. Moreover, read/sec and write/sec that are the modules of the performance statistics means modules that are configured in advance, such as a data transfer rate=data volume (MB)/sec, a transfer rate=number of transactions/sec, etc.

### <Flowchart of Analysis>

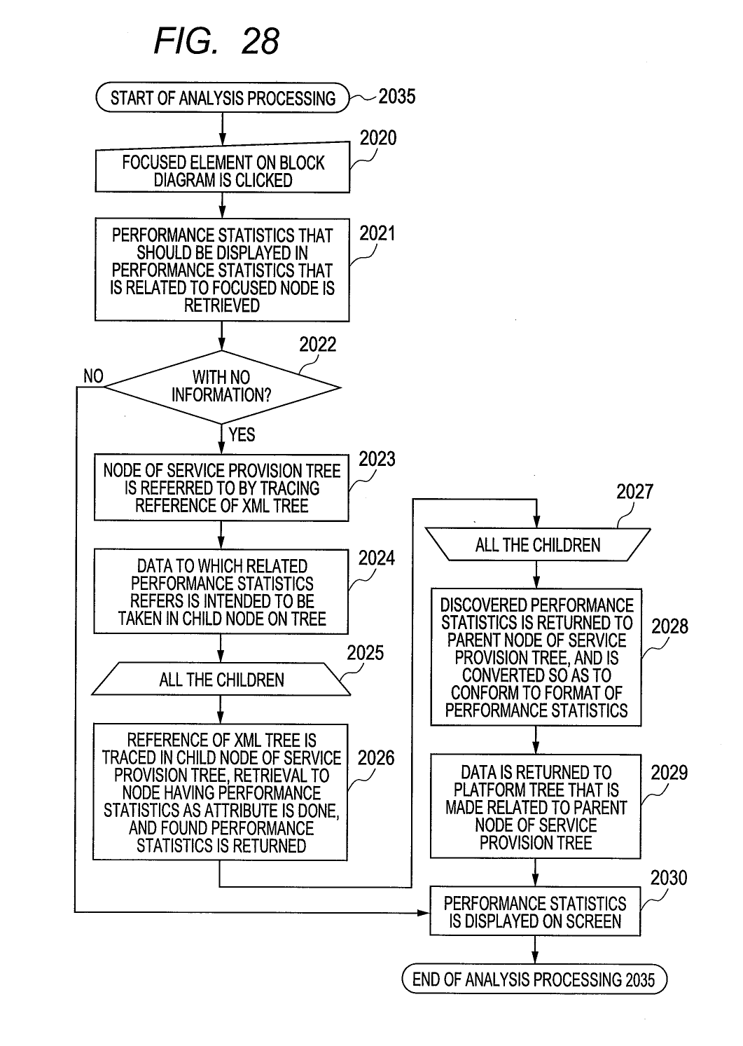

A flow of an analysis processing 2035 of FIG. 29 that the monitoring system 100 performs will be explained using FIG. 28.

In the terminal 350, when a selection operation (clicking etc.) is accepted from the system configuration diagram where the system components (components of the virtualized physical resources=the base resources 410) focused by the user of the monitoring system 100 are displayed on the screen of FIG. 9 (Step 2020), the flow proceeds to Step 2021.

At Step 2021, the monitoring system 100 searches the configuration information management table 130 for the performance statistics that is related with the system component (the HBA 415 of FIG. 25) being selected by the selection operation. When the performance statistics has been registered, the flow shifts to Step 2030, where the performance statistics is displayed on the screen, and the processing is terminated. When the performance statistics has not been registered, the flow moves to Step 2023 (Step 2022).

At Step 2023, the monitoring system 100 traces the platform tree 600 to reach the service provision tree 610 that has the cross-reference, and retrieves the child node (the vHBA 4650 of FIG. 25) of the service provision tree 610. Then, the monitoring system 100 acquires the statistics ID=4001 and the statistics ID=4002 as the performance statistics of the HBA on the service provision tree that is related with the child node (the vHBA 4650). Next, the monitoring system 100 refers to data that is specified by the operation 204 in the record of the statistics ID of the child node retrieved by referring to the performance statistics analysis table 115 (Step 2024).

In FIG. 26, the statistic of the link destination component that is specified by a column of the operation 2004 of the statistics ID 4001 or 4002 is retrieved. The link destination referred to here means a node on the platform tree 600 that is specified by xpath (FIG. 32A, FIG. 32B). At Steps 2025, 2026, and 2027, the statistic is retrieved in all the child nodes connected to the parent node that is focused (that is clicked) on the service provision tree 610, and the discovered statistic is returned. The flow proceeds to Step 2028 after termination of the above-mentioned processing.

At Step 2028, the discovered performance statistics is converted into a representation form of the parent node specified by the performance statistics analysis table 115 in the performance information management module 190, and the flow proceeds to Step 2029.

At Step 2029, the performance information GUI control module 260 displays numerical values on the screen of the terminal 350 as statistics of the nodes of the platform tree that have the cross-references with the parent node of the service provision tree (Step 2030).

By the above-mentioned processing, the performance statistics (2041) of FIG. 29 is displayed in a predetermined graph on the display device of the terminal 350.

### <Modification>

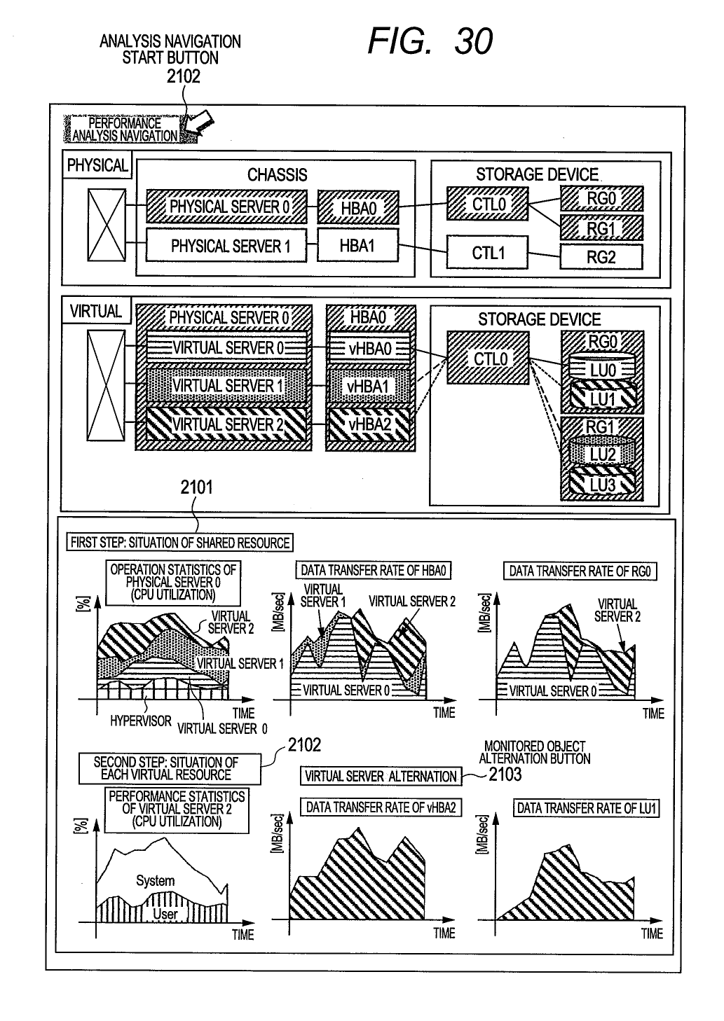

A performance analysis navigation system will be explained as a modification of the present invention. An outline of the system will be explained using FIG. 30. Displaying relation of the configuration information and the performance statistics on a single screen is the same as that of the embodiment described previously. When an analysis navigation start button 2102 on the screen of the display device of the terminal 350 is selected (clicked) with the input device etc., the stacked bar chart of a situation of utilization of the virtual resources (virtual resources 420) that share the base resources including the physical resources is displayed (the first step: situation of the shared resources 210).

For example, there are enumerated a graph (the CPU utilization) for determining how much the virtual servers (0 to 2) use the physical CPU (processor 412) of the physical server 411, the stacked bar chart (data transfer rate of the HBA0) of an IO throughput for determining how much the each virtual server uses the HBA, etc.

The administrator can determine which virtual server 0-2 uses the physical resources much and which server's 0-2 operation is affected in operation by seeing this graph. Furthermore, by the administrator operating the monitor object switching button 2103 with the input device of the terminal 350, a graph of the performance statistics measured by each of the virtual servers 0-2 (for example, the CPU utilization, the IO throughput, etc.) is displayed, which enables the administrator to verify each operational condition. Thus, it is possible to support a performance analysis in the virtualized computer system.

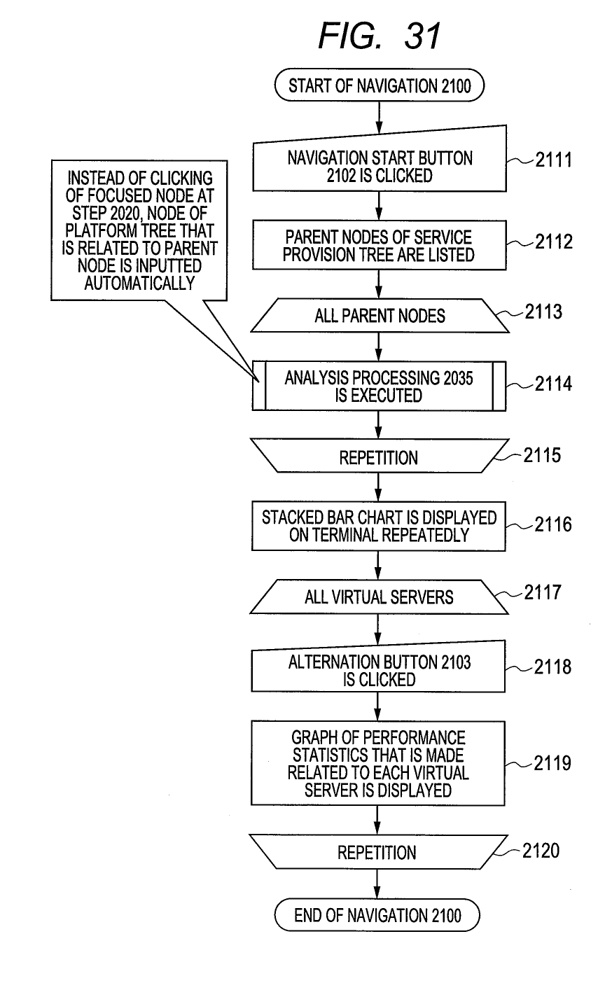

Operations of the performance analysis navigation system will be explained using a flowchart of FIG. 31. First, the monitoring system 100 displays an initial screen of the navigation on the terminal 350 (start of navigation 2100). The administrator of the system clicks the navigation start button 2102 on the screen that is displayed with the input device etc. of the terminal 350, and when the monitoring system 100 accepts a signal from the input device of the terminal 350 (Step 2111), the flow proceeds to Step 2112.

At Step 2112, in the monitoring system 100, the performance information GUI control module of FIG. 2 notifies the performance information management module 190 of navigation start. The performance information management module 190 gives the configuration information management module 200 an instruction to list the parent nodes of the service provision tree 610, and the flow proceeds to Step 2113.

At Step 2113, the analysis processing 2035 of FIG. 28 is performed on the parent nodes listed by the configuration information management module 200 (Step 2114). However, other than the user specifying the focused node by clicking at Step 2502, the node of the platform tree 600 with which the parent node of the service provision tree 610 having been listed is related is inputted. This implies, for example, the HBA 415 of the platform tree 600 that is given the cross-reference to the HBA 4150 of the service provision tree 610 of FIG. 25. When the processing is terminated for one node, the same processing will be performed on the next node (Step 2115).

When the processing of all the parent nodes is terminated, the stacked bar chart is displayed on the terminal 350. Next, at Steps 2117, 2118, 2119, and 2120, the processing of generating a graph is performed for the performance statistics of all the servers. Since processings necessary to display the graph is performed in a procedure of FIG. 14 that has already been explained, they are omitted here.

Since if pieces of information of all the virtual servers 0-2 are displayed on the screen of the display device of the terminal 350 at a time, it becomes difficult for the administrator to decide which part should be seen; therefore, when the monitoring system 100 accepts an operation of the monitored object switching button 2103 on the screen, displayed data is switched. At Step 2119, the monitoring system 100 outputs the performance statistics related with each of the virtual servers 0-2 to the display device of the terminal 350. Processing is terminated after the above-mentioned processes are repeated for all the virtual servers 0-2 (Step 2120).

By the above-mentioned processing, it is possible to display the physical configuration of the base resources 410 constituting the monitored resources 400 and the virtualized configuration of the virtual resources 420 onto the display device of the terminal 350, and to display a situation of utilization (2101) of the resources of all the virtual servers that share the physical server 411 being the component of the base resources 410 and a situation of utilization of the resources of each server as graphs, respectively.

As described above, according to the embodiment and the modification of the present invention, the monitored resources 400 are divided into the base resources 410 including the physical resources and the virtual resources 420 including the virtual resources using the resources of the base resources 410. Then, it becomes possible to manage the configuration information and the performance statistics regarding the relationship of the components between the base resources 410 and the virtual resources 420 without omission and using a small amount of time. The performance statistics of the base resources 410 or the virtual resources 420 enables the monitoring system 100 to easily analyze the performance statistics of each virtual resource that shares the physical resources (resources of the base resource 410) from an arbitrary component. Moreover, by analyzing the performance statistics according to the data structure of the configuration information, it becomes possible to navigate the management of the performance statistics that is efficient for the administrator who uses the monitoring system 100 etc. By these capabilities, it becomes possible to shorten a time until detecting a bottleneck of the computer resources from the operation information, and to improve the efficiency of the administrator who spends man-hour in operation and management in the computer system having a large number of computers, especially a large number of virtual servers.

As compared with Japanese Unexamined Patent Application Publication (Translation of PCT application) No. 2007-524889 of the above-mentioned conventional technology, by classifying the configuration information into the platform tree 600 and the service provision tree 610 of the tree structure according to the present invention, and by defining the cross-reference of the tree structure, it becomes possible to easily manage addition and change of the component.

Since a cost of addition and deletion of the component of the monitored resources 400 does not depend on the number of servers, the addition and deletion can be executed at the cost of O(1) time because the change is only in a portion to which the server is related. Designating the number of servers by S, it can be said that the cost is O(S) because the data volume is proportional to the number of servers. Therefore, as compared with the conventional technology, it is possible for the method of this invention to reduce the cost.

Moreover, in the above-mentioned embodiment, although an example where the monitoring system 100, the configuration manager 360, and the performance statistics collector 300 operated on different computers was shown, these can operate on the same computer and in this case the monitoring module, the configuration management module, and the performance statistics collector can be implemented as software.

As described above, it is applicable for the monitoring system of a computer according to the present invention to be applied to a computer system that has a physical server and a virtual server and manages the history of the configuration information or performance statistics.

What is claimed is:

1. A monitoring system of a computer, comprising:
one or more physical computers;
a virtualization module that is executed by the physical computers to make one or more virtual computers operate;
the one or more virtual computers that operate on the virtualization module; and
a monitoring module for monitoring components of the physical computers and components of the virtual computers;
wherein the monitoring module
designates physical resources that are the components of the physical computers and the components of the virtualization module conjunctionally as base resources,
manages the components of the virtual computers operating on the virtualization module as virtual resources,
generates a platform tree by extracting a tree structure from the components of the virtual resources and the components of the base resources for every predetermined platform,
generates a service provision tree by extracting a tree structure that has the base resources being configured by predetermined transformation information or the virtual resources as its starting points from the components of the virtual resources,
configures reference information indicating referring to the components that are contained in the platform tree and are contained in the service provision tree, and
establishes reference relationships of the components between the platform tree and the service provision tree.

2. The monitoring system of a computer according to claim 1,
further comprising a performance statistics collector for generating performance statistics by collecting operation information of the base resources and the virtual resources and performing a predetermined statistical processing on the operation information,
wherein the monitoring module gives unique identifies to the base resources, the virtual resources, and the performance statistics, respectively, and
sets the identifiers of the base resources or the virtual resources that were collected from the operation information as the parent identifier in the performance statistics.

3. The monitoring system of a computer according to claim 1,
wherein the transformation information configures a higher-rank component for generating the virtual resources by visualizing or logicalizing the component among the components of the base resources, and
a lower-rank component that is obtained by visualizing or logicalizing the higher-rank component to generate a virtual resource and by dividing it into a plurality of components.

4. The monitoring system of a computer according to claim 3,
wherein the monitoring module has a GUI control module for outputting the component of the higher-rank components, the component of the lower-rank components, and the performance statistics of the higher-rank components and the lower-rank components as on a single screen.

5. The monitoring system of a computer according to claim 4,
wherein the GUI control module accepts the component of the higher-rank components or the lower-rank components and outputs the configuration information that has been related with the accepted component.

6. A computer monitoring method for monitoring resources of a computer that is for a monitoring system comprising:
one or more physical computers;
a virtualization module that is executed by the physical computers to make one or more virtual computers operate;
the one or more virtual computers operating on the virtualization module;
components of the physical computers; and components of the virtual computers;
including:
a first step where the monitoring module acquires the components of physical resources and the components of the virtualization module, respectively, and manages them as base resources;
a second step where the monitoring module acquires the components of the virtual computers operating on the virtualization module and manages them as virtual resources;
a third step where the monitoring module generate a platform tree by extracting a tree structure of the components of the virtual resources and the components of the base resources for every predetermined platform;
a fourth step of generating a service provision tree by extracting a tree structure that has the base resources being configured by predetermined transformation information or the virtual resources as its starting points from the components of the virtual resources; and
a fifth step of configuring reference information that indicates referring to the components contained in the platform tree and also contained in the service provision tree and establishing reference relationships of the components of the platform tree and the service provision tree.

7. The method for monitoring a computer according to claim 6,
further comprising:
a sixth step where the monitoring module collects the operation information of the base resources and the virtual resources and generates the performance statistics by performing a predetermined statistical processing on the operation information; and
a seventh step where the monitoring module gives unique identifiers to the base resources, the virtual resource, and the performance statistics, and configures the identifiers of the base resources or the virtual resources whose operation information is collected as the identifiers of the parent in the performance statistics.

8. The method for monitoring a computer according to claim 6,
wherein the transformation information configures higher-rank components for generating virtual resources by virtualizing or logicalizing the components among the components of the base resources
and lower-rank components that divide the higher-rank components into a plurality of components of the virtual resources by virtualizing or logicalizing the higher-rank components.

9. The method for monitoring a computer according to claim 8,
further comprising an eighth step
wherein the monitoring module outputs the component of the higher-rank components, the component of the lower-rank components, and the performance statistics of the higher-rank components and the lower-rank components as on a single screen.

10. The monitoring method of a computer according to claim 9,
wherein in the eighth step, the monitoring module accepts the component of the higher-rank components or the lower-rank components and outputs the performance statistics that has been related the accepted component.
